(19) United States
(12) Patent Application Publication
(10) Pub. No.: US 2026/0190083 A1
(43) Pub. Date: Jul. 2, 2026

(54) Generative AI-Based Multi-Base Station Collaborative Sensing Resource Optimization Method and Apparatus

(71) Applicant: BEIJING UNIVERSITY OF POSTS AND TELECOMMUNICATIONS, Beijing (CN)

(72) Inventors: Zhiyong FENG, Beijing (CN); Qixun ZHANG, Beijing (CN); Ruotong LI, Beijing (CN); Ping ZHANG, Beijing (CN); Dingyou MA, Beijing (CN); Kan YU, Beijing (CN); Zhiqing WEI, Beijing (CN); Sai HUANG, Beijing (CN); Ningyan GUO, Beijing (CN); Weiqi GAO, Beijing (CN)

(21) Appl. No.: 19/434,511

(22) Filed: Dec. 29, 2025

(30) Foreign Application Priority Data
Dec. 30, 2024 (CN) 202411972316.7

(51) Int. Cl. H04W 72/04; H04W 4/38

(52) U.S. Cl. CPC H04W 72/04; H04W 4/38

(57) ABSTRACT

Provided are a generative AI-based multi-base station collaborative sensing resource optimization method. The generative AI-based multi-base station collaborative sensing resource optimization method includes: acquiring first communication and sensing related information of a first multi-base station collaborative ISAC system; inputting the first communication and sensing related information into a trained AI resource optimization model to obtain first resource allocation information of the first multi-base station collaborative ISAC system and/or a first sensing mode of the first multi-base station collaborative ISAC system output by the AI resource optimization model. The present invention breaks through the limitations of traditional fixed resource allocation, enables to generalize to new scenario requirements based on existing scenario information, dynamically adjusts the sensing mode and resource allocation strategy, has certain robustness, and enables to adapt to dynamic environmental changes, solving the problems of low resource utilization efficiency and limited communication sensing performance caused by insufficient system flexibility.

The present application claims the priority to a Chinese patent application 202411972316.7 filed with the China National Intellectual Property Administration (CNIPA) on Dec. 30, 2024, and entitled “GENERATIVE AI-BASED MULTI-BASE STATION COLLABORATIVE SENSING RESOURCE OPTIMIZATION METHOD AND APPARATUS”, which is incorporated herein by reference in its entirety.

### TECHNICAL FIELD

The application relates to the technical field of integrated sensing and communication (ISAC), in particular to a generative Artificial Intelligence (AI)-based multi-base station collaborative sensing resource optimization method.

### BACKGROUND

In future mobile communication networks, ISAC implements communication and environmental sensing functions through the same platform, and is widely used in scenarios such as unmanned aerial vehicle monitoring, autonomous driving, and intelligent transportation system, significantly improving the overall efficiency of the network. For example, a base station can simultaneously perform target detection and tracking while providing communication services. With the increasing complexity of an application scenario, it is difficult for a single base station to support wide-area and multi-target sensing requirements due to limited coverage and resources. To this end, multi-base station collaborative ISAC system optimizes resource allocation and coordination through the joint operation of multiple base stations, improving sensing accuracy and communication quality. Collaborative optimization among base stations may be achieved through methods such as joint beamforming, power allocation, and resource scheduling, to expand sensing coverage, balance communication and sensing performance, and provide support for efficient operation in complex dynamic scenarios.

However, existing multi-base station collaborative ISAC systems have limitations in resource allocation and system optimization, mainly reflected in the fact that a fixed sensing mode restricts flexibility of the systems and leads to low resource efficiency.

At present, the resource allocation optimization schemes for multi-base station collaborative ISAC systems typically adopt an active sensing mode or a passive sensing mode (i.e., the fixed sensing mode is the active sensing mode or passive sensing mode), and perform, based on this, interference modeling and resource optimization. However, there are significant differences in the propagation path, channel state, and interference characteristic for a signal in different sensing modes. For example, in the active sensing mode, the base station continuously transmits sensing signals, resulting in a high sensing echo power, and weak echo signals from neighboring base stations are often regarded as interference; whereas in the passive sensing mode, the system relies on low-power echo signals in the environment, and the channel state and interference characteristic are more susceptible to changes in the external environment. Therefore, adopting a fixed sensing mode cannot adapt to real-time changes in the dynamic environment and task requirements based on channel state and interference level. In scenarios with high interference or limited resources, a fixed sensing mode may lead to unreasonable resource allocation, resulting in resource waste or insufficient sensing performance. In a multi-target task scenario, the fixed sensing mode is also difficult to dynamically adjust resource scheduling and sensing strategy in combination with the importance of different targets and real-time changes in a task, thereby limiting the collaborative optimization effect of communication and sensing tasks and affecting the overall performance of the system.

In summary, existing multi-base station collaborative ISAC systems adopting the fixed sensing mode have difficulty in adapting to dynamic environmental changes, and have low resource utilization efficiency caused by insufficient system flexibility, and limited communication and sensing performance.

### SUMMARY

The present invention provides an Artificial Intelligence (AI)-based multi-base station collaborative sensing resource optimization method and apparatus, which are used to solve the problems that existing multi-base station collaborative ISAC systems adopting the fixed sensing mode have difficulty in adapting to dynamic environmental changes, and have low resource utilization efficiency caused by insufficient system flexibility, and limited communication and sensing performance.

To solve the above technical problems, embodiments of the present invention provide the following technical solutions.

In a first aspect, an embodiment of the present invention provides a generative AI-based multi-base station collaborative sensing resource optimization method, including:
acquiring first communication and sensing related information of a first multi-base station collaborative ISAC system; and
inputting the first communication and sensing related information into a trained AI resource optimization model to obtain first resource allocation information of the first multi-base station collaborative ISAC system and/or a first sensing mode of the first multi-base station collaborative ISAC system output by the AI resource optimization model;
wherein the AI resource optimization model is configured to indicate at least one of:
a correspondence between communication and sensing related information and resource allocation information;
a correspondence between communication and sensing related information and a sensing mode.

In a second aspect, an embodiment of the present invention further provides a generative AI-based multi-base station collaborative sensing resource optimization apparatus, including: a processor, a memory, and a program stored on the memory and executable on the processor, wherein the program, when executed by the processor, carries out the generative AI-based multi-base station collaborative sensing resource optimization method in the first aspect.

In a third aspect, an embodiment of the present invention further provides a non-transitory readable storage medium having stored thereon a program, wherein the program, when executed by a processor, carries out the generative AI-based multi-base station collaborative sensing resource optimization method in the first aspect.

The beneficial effects of the present invention are:

In the generative AI-based multi-base station collaborative sensing resource optimization method provided by the solutions of the present invention, an AI resource optimization model is obtain by training, the first communication and sensing related information of the first multi-base station collaborative ISAC system is input into the AI resource optimization model, and the first resource allocation information of the first multi-base station collaborative ISAC system output by the AI resource optimization model is obtained by using the correspondence between the communication and sensing related information and the resource allocation information indicated in the AI resource optimization model, and/or, the first sensing mode of the first multi-base station collaborative ISAC system output by the AI resource optimization model is obtained by using the correspondence between the communication and sensing related information and the sensing mode indicated in the AI resource optimization model, breaking through the limitation of traditional fixed resource allocation, enabling to generalize to new scenario requirements according to existing scenario information, dynamically adjusting the sensing mode and resource allocation strategy, having certain robustness, and enabling to adapt to dynamic environmental changes, solving the problems of low resource utilization efficiency and limited communication and sensing performance caused by insufficient system flexibility.

### BRIEF DESCRIPTION OF THE DRAWINGS

FIG. 1 shows a flowchart of a generative AI-based multi-base station collaborative sensing resource optimization method provided by an embodiment of the present invention;

FIG. 2 shows a schematic diagram of multi-base station collaborative communication and sensing method in an active sensing mode provided by an embodiment of the present invention;

FIG. 3 shows a flowchart of acquiring resource allocation information in an active sensing mode provided by an embodiment of the present invention;

FIG. 4 shows a flowchart of acquiring resource allocation information in a collaborative sensing mode provided by an embodiment of the present invention;

FIG. 5 shows a schematic diagram of multi-base station collaborative communication and sensing provided by an embodiment of the present invention;

FIG. 6 shows a training process of an AI resource optimization model provided by an embodiment of the present invention;

FIG. 7 shows a schematic diagram of a structure of a generative AI-based multi-base station collaborative sensing resource optimization apparatus provided by an embodiment of the present invention.

### DETAILED DESCRIPTION

In order to make the technical problems, technical solutions, and advantages of the present application more clearly, detailed description will be provided in combination with the accompanying drawings and specific embodiments below. In the following description, specific details such as specific configurations and components are provided only to assist in a comprehensive understanding of the embodiments of the present application. Therefore, it should be clear to those skilled in the art that various changes and modifications can be made to the embodiments described herein without departing from the scope and spirit of the present application. In addition, descriptions of known functions and constructions are omitted for clarity and conciseness.

It should be understood that the mention of “one embodiment” or “an embodiment” throughout the specification means that specific features, structures, or characteristics related to the embodiment is included in at least one embodiment of the present application. Therefore, the appearance of “in one embodiment” or “in an embodiment” throughout the specification does not necessarily refer to the same embodiment. Furthermore, the specific features, structures, or characteristics may be combined in one or more embodiments in any suitable manner.

In various embodiments of the present application, it should be understood that the sequence numbers of the following processes do not imply the execution order, and the execution order of each process should be determined by its function and internal logic, and should not constitute any limitation on the implementation process of the embodiments of the present application.

In the embodiments provided by the present application, it should be understood that “B corresponding to A” means that B is associated with A, and B may be determined according to A. But it should also be understood that determining B according to A does not mean determining B solely according to A, and B may also be determined according to A and/or other information.

The term “and/or” in the embodiments of the present invention describes the association relationship between associated objects, indicating that there can be three types of relationships. For example, A and/or B may indicate: A exists alone, A and B exist simultaneously, and B exists alone. The character “/” generally indicates that the associated objects before and after “/” are in an “or” relationship.

To solve the problems that existing multi-base station collaborative ISAC systems adopting the fixed sensing mode have difficulty in adapting to dynamic environmental changes, and have low resource utilization efficiency caused by insufficient system flexibility, and limited communication and sensing performance, embodiments of the present invention provide a generative AI-based multi-base station collaborative sensing resource optimization method and apparatus.

As shown in FIG. 1, an embodiment of the present invention provides a generative AI-based multi-base station collaborative sensing resource optimization method, including:

Step 101: acquiring first communication and sensing related information of a first multi-base station collaborative ISAC system.

The first multi-base station collaborative ISAC system may be any multi-base station collaborative ISAC system. The first multi-base station collaborative ISAC system is a system to perform sensing resource allocation optimization.

The communication and sensing related information includes at least one of the following:
base stations, wherein the communication and sensing related information further includes position information, quantity information, etc., of the base stations;
a communication user, wherein the communication and sensing related information further includes position information, quantity information, type information and the like of the communication user, wherein the type information of the communication user includes a vehicle, and a user equipment (UE);
sensing targets, wherein the communication and sensing related information further includes position information, quantity information and the like of the sensing target; in this embodiment, an unmanned aerial vehicle (UAV) is taken as an example of a sensing target for description;
resource constraint information, wherein the resource constraint information includes at least one of: a Signal-to-Interference-plus-Noise Ratio (SINR) threshold, the maximum number of beams supported by a base station, a maximum transmission power supported by a base station; and
communication and sensing indicator information, wherein the communication and sensing indicator information includes at least one of: downlink communication signals received by a communication user from the base stations, an echo signal reflected by the sensing targets and received by each of the base stations, power allocation information of the base stations, beam power allocation information of the base stations, transmission signals of the base stations, a reception signal of a communication user communicating with the base station, interference for a sensing target received by the base station.

That is, in this step, the first communication and sensing related information of the first multi-base station collaborative ISAC system to be optimized for resource allocation, is acquired, and this first communication and sensing related information is used for subsequent resource allocation optimization.

Step 102: inputting the first communication and sensing related information into a trained AI resource optimization model to obtain first resource allocation information of the first multi-base station collaborative ISAC system and/or a first sensing mode of the first multi-base station collaborative ISAC system output by the AI resource optimization model;
wherein the AI resource optimization model is configured to indicate at least one of the following:
   a correspondence between communication and sensing related information and resource allocation information; and
   a correspondence between communication and sensing related information and a sensing mode.

That is, in this step, first, the AI resource optimization model is trained using historical data. The correspondence between the communication and sensing related information and the resource allocation information and/or the correspondence between the communication and sensing related information and the sensing mode, are stored in the AI resource optimization model.

The first communication and sensing related information is input into the trained AI resource optimization model, to obtain the first resource allocation information of the first multi-base station collaborative ISAC system output by the AI resource optimization model by using the correspondence between communication and sensing related information and resource allocation information, and/or, to obtain the first sensing mode of the first multi-base station collaborative ISAC system output by the AI resource optimization model by using the correspondence between communication and sensing related information and a sensing mode. That is, the model decides the sensing method and resource allocation, breaking through the limitation of traditional fixed resource allocation, enabling to generalize to new scenario requirements according to existing scenario information, dynamically adjusting the sensing mode and resource allocation strategy, having certain robustness, and enabling to adapt to dynamic environmental changes, thus solving the problems of low resource utilization efficiency and limited communication and sensing performance caused by insufficient system flexibility.

The sensing mode includes at least one of the following:
an active sensing mode, wherein the active sensing mode is a mode in which, in the multi-base station collaborative ISAC system, both of transmitting a sensing signal and receiving an echo signal reflected by a sensing target are performed by the same base station; and
collaborative sensing mode, wherein the collaborative sensing mode is a mode in which, in the multi-base station collaborative ISAC system, one base station transmits a sensing signal, and another different base station receives an echo signal reflected by a sensing target.

Further, the communication and sensing related information includes:
communication and sensing related information in the active sensing mode; and
communication and sensing related information in the collaborative sensing mode.

It should be noted that the active sensing mode may also be called the A-transmitting and A-receiving mode. In the A-transmitting and A-receiving mode, the base station is responsible for both transmitting a signal and receiving an echo for the signal, achieving active sensing. This mode is suitable for high-precision sensing tasks within the range of a single base station. The key features of this mode are as follows: signal modeling, where the base station transmits a sensing signal and receives an echo signal reflected from a target, and in this mode, the signal modeling of the base station is based on the Cramer-Rao Lower Bound (CRLB), and the sensing accuracy is optimized by minimizing the CRLB; beam and power allocation, where the base station performs beamforming and power allocation while transmitting a signal to ensure accurate sensing of the target, and the base station is enabled to utilize resources more efficiently in sensing tasks through the optimization of CRLB; application scenarios, where this mode is suitable for tasks requiring higher sensing accuracy, such as precise positioning and tracking of an unmanned aerial vehicle target. In this mode, the base station can independently complete a sensing task without relying on collaboration with other base stations.

The collaborative sensing mode may also be called the A-transmitting and B-receiving mode. In the A-transmitting and B-receiving mode, a sensing task is completed through collaboration among multiple base stations. Base Station A is responsible for transmitting a sensing signal, and Base Station B receives and processes an echo signal, thereby achieving sensing of a target. The key features of this mode are as follows: signal modeling, where in the A-transmitting and B-receiving mode, Base Station A transmits a communication and sensing signal, and Base Station B is responsible for receiving a sensing signal reflected from a target, expanding the sensing coverage and improving the quality of the sensing signal through multi-base station collaboration; beam and power allocation, where the system needs to reasonably allocate power and beam directions among multiple base stations due to the collaboration of multiple base stations, to avoid mutual interference among the base stations and ensure the overall performance of the system is optimal, thus beamforming and power allocation are more complex in this mode and require coordinating the resources of the multiple base stations; application scenarios, where this mode is suitable for scenarios with wider coverage and higher target complexity, such as unmanned aerial vehicle swarms or large-scale monitoring tasks. The collaboration of multiple base stations can improve sensing accuracy of the system for a target and anti-interference capability.

The training process of the AI resource optimization model provided by an embodiment of the present invention is specifically described below.

In one embodiment, the method further includes:
acquiring second communication and sensing related information, a second sensing mode, and second resource allocation information of a second multi-base station collaborative ISAC system;
   There can be one or more second multi-base station collaborative ISAC systems which are systems used for model training.
   It should be noted that parameters in the second communication and sensing related information are the same as those in the first communication and sensing related information, differing only in specific values of the parameters.
   The second resource allocation information is obtained according to the second communication and sensing related information, and the second sensing mode is set according to requirements such as the application scenario of the multi-base station collaborative ISAC system and the like.
training by using the second communication and sensing related information and the second sensing mode, and/or using the second communication and sensing related information and the second resource allocation information, to obtain the AI resource optimization model.

Specifically, training is performed by using the second communication and sensing related information and the second sensing mode to obtain a correspondence between communication and sensing related information and a sensing mode in the AI resource optimization model through; and training is performed by using the second communication and sensing related information and the second resource allocation information to obtain a correspondence between communication and sensing related information and resource allocation information in the AI resource optimization model.

In an optional embodiment, the process of acquiring communication and sensing related information in the active sensing mode is specifically described below.

In the active sensing mode, a base station is equipped with a Massive Multiple-Input Multiple-Output (mMIMO) Uniform Planar Array (UPA), possessing the capability to sense through ISAC technology. The base station uses independent transmitting and reception antennas, enabling to receive sensing echo signals while maintaining downlink communication.

For this mode, the embodiment of the present invention models the relationship between downlink communication signals and active sensing echo signals and the transmission beams of the base stations in a multi-base station collaboration scenario, and derives the SINR expression for a ground communication user and CRLB for the sensing performance for unmanned aerial vehicle (UAV). By minimizing the CRLB, the sensing accuracy is improved when the position of the unmanned aerial vehicle (i.e., the sensing target) is approximately known.

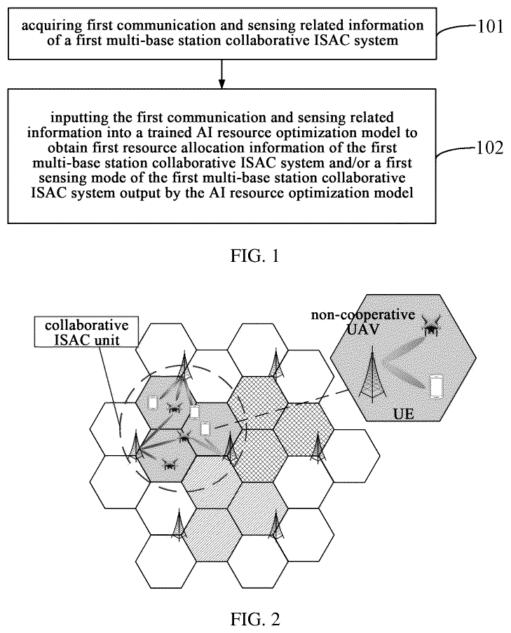

That is, in this optional embodiment, acquiring the second resource allocation information of the second multi-base station collaborative ISAC system includes:
acquiring downlink communication signals received by a communication user from base stations, an echo signal reflected by sensing targets and received by each of the base stations, and beam power allocation information of the base stations, in the second multi-base station collaborative ISAC system in an active sensing mode.
   Specifically, in this active sensing mode, all base stations (ISAC BSs) provide sensing and communication services simultaneously in a multi-beam mode. In terms of communication service, ground communication users with different Quality of Service (QoS) requirements for downlink communication are considered, such as a vehicle and UE. In terms of sensing service, each ISAC BS receives an echo of its own transmission signal, which is reflected by UAV. By analyzing the reflected signal, each ISAC BS uploads its positioning result to a fusion center for data integration. Similar to a ground communication user, UAV exhibit different threat levels in different regions, thus having different sensing QoS requirements.
   In this active sensing mode, please refer to FIG. 2. FIG. 2 is a schematic diagram of multi-base station collaborative communication and sensing method in the active sensing mode. Three adjacent sectors of three adjacent BSs are regarded as one collaborative integrated sensing and communication unit, i.e., one collaborative ISAC unit (referring to areas of the same shadow in the figure). The non-cooperative unmanned aerial vehicles shown in FIG. 2 are the sensing targets. In the collaborative ISAC unit, the sensing targets include K UAVs, and the communication users include M single-antenna UEs. Each base station is equipped with Nₜ transmitting antennas and Nᵣ reception antennas, each being UPA. The base stations transmit multiple beams to UAVs or UEs through beamforming (BF) technology. Each UAV may reflect beams from one or more BSs, and after the base stations receive the echoes from this UAV, sensing signal-level fusion is performed at one base station through data interaction among the base stations to obtain the sensing result; meanwhile, the base stations transmit multiple beams for downlink data transmission with UEs.
   A baseband signal of the n-th base station is defined as:

$${s}_{n} ( t ) = {[ {s}_{1 , n} ( t ) , … , {s}_{J , n} ( t ) ]}^{T} ∈ {ℂ}^{J \times 1} ,$$

wherein J=K+M, representing the sum of the number of UAVs and the number of UEs. The ISAC signal after beamforming is:

$${\tilde{s}}_{n} ( t ) = {F}_{n} ( {g}_{n} ⊗ {s}_{n} ( t ) ) = {\sum }_{j = 1}^{J} {f}_{j , n} {g}_{j , n} {s}_{j , n} ( t ) ∈ {ℂ}^{{N}_{t} \times 1} , \qquad ( 1 )$$

wherein s_{j,n}(t) is the j-th element of sₙ(t), and represents a baseband signal sent to the j-th target (such as an UAV or UE) form the n-th base station; Fₙ=[f_{1,n}, f_{2,n}, . . . , f_{J,n}]∈ [symbol] ^{N}^{ₜ}^{×j}, representing a transmission beam beamforming matrix; gₙ=[g_{1,n}, g_{2,n}, . . . , g_{J,n}]^{T}∈ [symbol] ^{J×1} represents a beam selection vector, where when the binary variable g_{j,n} is set to value 1, it indicates that the Base Station n allocates a beam directing to Sensing Target j, and when the binary variable g_{j,n} is set to 0, it indicates that the base station does not allocate a beam directing to Sensing Target j.
For communication UEs, a downlink communication signal received by the m-th UE from the n-th base station is:

$${y}_{m} ( t ) = {\sum }_{n = 1}^{N} \tilde{o} \sqrt{{α}_{m , n} {p}_{m , n}} {a}_{{N}_{t}}^{H} ( {φ}_{m , n} , {θ}_{m , n} ) {f}_{m , n} {g}_{m , n} {s}_{m , n} ( t ) + {\sum }_{n = 1}^{N} {\sum }_{l \neq m , l ∈ ℳ} \tilde{o} \sqrt{{α}_{m , n} {p}_{i , n}} {a}_{{N}_{t}}^{H} ( {φ}_{m , n} , {θ}_{m , n} ) {f}_{i , n} {g}_{i , n} {s}_{i , n} ( t ) + {\sum }_{n = 1}^{N} {\sum }_{k = 1}^{K} \tilde{o} \sqrt{{α}_{m , n} {p}_{k , n}} {a}_{{N}_{t}}^{H} ( {φ}_{m , n} , {θ}_{m , n} ) {f}_{k , n} {g}_{k , n} {s}_{k , n} ( t ) + {n}_{dl} , \qquad ( 2 )$$

wherein N represents the total number of collaborative base stations, õ=\sqrt{N}, represents an antenna gain, [symbol] represents a set of UEs, α_{m,n} represents a path loss between the m-th UE and the n-th base station, P_{m,n} represents a beam power allocated by the n-th base station to the m-th UE, P_{k,n} represents a beam power allocated by the n-th base station to the k-th UAV. P_{m,n} and P_{k,n} are both the beam power allocation information of the base station (the beam power allocation information of the base station includes P_{m,n} and P_{k,n}). φ_{m,n} and θ_{m,n} represent an azimuth angle and pitch angle of the m-th UE relative to the n-th base station respectively.

$${n}_{dl} \sim CN ( 0 , {σ}_{dl}^{2} )$$

represents additive white Gaussian noise with a variance of

$${σ}_{dl}^{2} ,$$

a_{N}_{ₜ}(φ, θ) represents a steering vector of a transmitting antenna, which is calculated as:

$${a}_{{N}_{t}} ( φ , θ ) = \sqrt{\frac{1}{{N}_{t}}} [ 1 , … , {e}^{j π [ ( {n}_{z} - 1 ) sin θ + ( {n}_{y} - 1 ) sin φ cos θ ]} , \qquad ( 3 )$$

$${… , {e}^{j π [ ( {N}_{z} - 1 ) sin θ + ( {N}_{y} - 1 ) sin φ cos θ ]} ]}^{T} \text{} ,$$

wherein N_{y} and N_{z} represent the number of antennas in each row and the number of antennas in each column in UPA respectively. Nₜ represents the number of transmitting antennas. n_{y} represents the index of an antenna in the row direction, taking a value of 1, 2, . . . , N_{y}. n_{z} represents the index of an antenna in the column direction, taking a value of 1, 2, . . . , N_{z}.
The echo signal received by the n-th base station and reflected from all UAVs is:

$${r}_{n} = {\sum }_{k = 1}^{K} \tilde{o} \sqrt{{β}_{k , n} {p}_{k , n}} {e}^{j 2 {πμ}_{k , {n}^{l}}} {a}_{{N}_{r}} ( {φ}_{k , n} , {θ}_{k , n} ) {a}_{{N}_{t}}^{H} ( {φ}_{k , n} , {θ}_{k , n} ) {f}_{k , n} {g}_{k , n} {s}_{k , n} ( t - {τ}_{k , n} ) + {n}_{rd} , \qquad ( 4 )$$

wherein õ=\sqrt{N,N}, represents an antenna gain, β_{k,n}, μ_{k,n}, and τ_{k,n} represent the reflection coefficient, Doppler frequency, and time delay of the k-th UAV relative to the n-th base station respectively.

$${n}_{rd} \sim CN ( 0 , {σ}_{rd}^{2} {I}_{{N}_{r}} )$$

is Gaussian white noise with a variance of

$${σ}_{rd}^{2} ,$$

Where I_{N}_{ᵣ} represents an unit matrix with dimension Nᵣ, φ_{k,n} and θ_{k,n} represent an echo azimuth angle of arrival (AoA) and echo zenith angle of arrival (ZoA) for the k-th UAV relative to the n-th base station respectively, a_{N}_{ᵣ}(φ, θ) represents a steering vector of a receiving antenna.
Furthermore, the beamformer is designed as follows:

$$\begin{matrix}\begin{matrix}{f}_{m , n} = {b}_{t} ( {\hat{φ}}_{m , n} , {\hat{θ}}_{m , n} ) \\ {f}_{k , n} = {b}_{t} ( {\hat{φ}}_{k , n} , {\hat{θ}}_{k , n} )\end{matrix} \\ {w}_{k , n} = {b}_{r} ( {\hat{φ}}_{k , n} , {\hat{θ}}_{k , n} )\end{matrix} , \qquad ( 5 )$$

wherein \hat{φ} and \hat{θ} represent the estimated pitch angle and azimuth angle; f_{m,n} represents the transmitting beamforming vector from the n-th base station directed to the m-th UE; f_{k,n} represents the transmitting beamforming vector from the n-th base station directed to the k-th UAV; w_{k,n} represents the reception beamforming vector for the n-th base station in the direction of the k-th UAV.
The transmitting beamforming function bₜ(φ, θ) is defined as:

$${b}_{t} ( φ , θ ) = \frac{{a}_{{N}_{t}} ( φ , θ )}{‖ {a}_{{N}_{t}} ( φ , θ ) ‖}$$

wherein a_{N}_{ₜ}(φ, θ) represents the a steering vector of a transmitting antenna.
The reception beamforming function bᵣ(φ, θ) is defined as:

$${b}_{r} ( φ , θ ) = \frac{{a}_{{N}_{r}} ( φ , θ )}{‖ {a}_{{N}_{r}} ( φ , θ ) ‖}$$

wherein a_{N}_{ᵣ}(φ, θ) is a steering vector of a reception antenna, with a similar structure to a_{N}_{ₜ}(φ, θ) and with a different dimension from a_{N}_{ₜ}(φ, θ).

Generating a first optimization objective for resource allocation optimization in the active sensing mode according to the echo signal reflected by the sensing targets and received by each of the base stations, i.e., generating the first optimization objective according to the above formula (4).

Generating a first optimization constraint condition for resource allocation optimization in the active sensing mode according to the downlink communication signals received by the communication user from the base stations and the beam power allocation information of the base stations. The modeled optimization problem is obtained according to the first optimization objective and the first optimization constraint condition.

Performing resource allocation optimization on the second multi-base station collaborative ISAC system in the active sensing mode according to the first optimization objective and the first optimization constraint condition, to obtain the second resource allocation information in the active sensing mode.

Optionally, generating the first optimization objective for resource allocation optimization in the active sensing mode according to the echo signal reflected by the sensing targets and received by each of the base stations includes:
performing separation and filtering processing on the echo signal reflected by the sensing targets and received by each of the base stations to obtain first filtered echo signals, specifically:
   according to formula (4), the echo from different UAVs may be separated by a spatial filter, and the filtered echo is:

$${r}_{k , n} = {w}_{k , n}^{H} {r}_{n} = \tilde{o} \sqrt{{β}_{k , n} {p}_{k , n}} \text{} {e}^{j 2 {πμ}_{k , {n}^{l}}} \text{} {w}_{k , n}^{H} \text{} {a}_{{N}_{r}} ( {φ}_{k , n} , {θ}_{k , n} ) {a}_{{N}_{t}}^{H} ( {φ}_{k , n} , {θ}_{k , n} ) \cdot {f}_{k , n} {g}_{k , n} {s}_{k , n} ( t - {τ}_{k , n} ) + {n}_{k , n} , \qquad ( 6 )$$

wherein w_{k,n} represents a reception beamforming vector of the n-th base station in a direction of the k-th UAV;

$${n}_{k , n} \sim CN ( 0 , {σ}_{s}^{2} )$$

represents additive white Gaussian noise with a variance

$${σ}_{s}^{2} .$$

Generating a CRLB for sensing performance of each of the sensing targets according to the first filtered echo signals.
Specifically, the embodiment of the present invention uses the CRLB to evaluate performance of the multi-base station collaborative sensing of UAV and derives its expression. Based on this, a beam and power allocation optimization problem for the multi-base station collaborative ISAC system is proposed, and subsequently a Multi-BS collaborative beam and power allocation (MCBPA) algorithm is proposed to solve this problem.
The derivation process of the sensing CRLB for UAV under multi-base station collaboration is as follows:
when the UAV position is approximately known prior information, the estimation performance may be improved by minimizing the CRLB. The CRLB, as the lower limit for the variance of various unbiased estimators, is the inverse of the Fisher Information Matrix (FIM), which can be written as:

$$𝔼 \{ ( {\hat{Θ}}_{k} - {Θ}_{k} ) {( {\hat{Θ}}_{k} - {Θ}_{k} )}^{T} \} ≽ {J}_{k}^{- 1} , \qquad ( 7 )$$

wherein [symbol] {*} represents the mathematic expectation; Θₖ=[dₖ, φₖ, θₖ]^{T}, is the true value of the distance, azimuth angle, and pitch angle of UAV; \hat{Θ}ₖ is the estimated value of Θₖ; Jₖ is given by:

$${J}_{k} = {\sum }_{n = 1}^{N} {J}_{k , n} = \frac{2}{{σ}_{s}^{2}} {\sum }_{n = 1}^{N} {( \frac{\partial {r}_{k , n}^{′}}{\partial {Θ}_{k , n}^{T}} )}^{H} ( \frac{\partial {r}_{k , n}^{′}}{\partial {Θ}_{k , n}^{T}} ) , \qquad ( 8 )$$

wherein

$${r}_{k , n}^{′}$$

is the echo without noise (i.e., the first filtered echo signal), J_{k,n} is a 3×3 matrix, where the (i, j)-th element is denoted as J_{k,n}(i, j). Thus, the sensing CRLB of the k-th UAV is obtained as follows:

$$CRLB ( {d}_{k} ) = {J}_{k}^{- 1} ( 1 , 1 ) = {( {\sum }_{n = 1}^{N} {p}_{k , n} {g}_{k , n} {α}_{1} {κ}_{k , n} )}^{- 1} \qquad ( 9 )$$

$$CRLB ( {φ}_{k} ) = {J}_{k}^{- 1} ( 2 , 2 ) = {( {\sum }_{n = 1}^{N} {p}_{k , n} {g}_{k , n} {α}_{2} {κ}_{k , n} )}^{- 1}$$

$$CRLB ( {θ}_{k} ) = {J}_{k}^{- 1} ( 3 , 3 ) = {( {\sum }_{n = 1}^{N} {p}_{k , n} {g}_{k , n} {α}_{3} {κ}_{k , n} )}^{- 1} ,$$

wherein α₁, α₂, and α₃ depend on parameters such as frequency, bandwidth, and the number of antennas of the base station, κ_{k,n} is given by:

$${κ}_{k , n} = \frac{{π}^{2} {β}_{k , n} {‖ {w}_{k , n}^{H} {a}_{N} \text{?} ( {φ}_{k} , {θ}_{k} ) {a}_{N}^{H} \text{?} ( {φ}_{k} , {θ}_{k} ) {f}_{k , n} ‖}^{2}}{{σ}_{s}^{2}} \text{?} \qquad ( 10 )$$

$$\text{?} \text{indicates text missing or illegible when filed}$$

Subsequently, optimization problem modeling for differentiated QoS sensing performance of UAVs is performed:
when optimizing multi-target sensing performance, existing techniques usually adopt methods such as minimizing the overall CRLB or minimizing the maximum CRLB. However, this may lead to resource allocation being concentrated on a single target. Under such criteria, the system tends to allocate resources to a target with the highest potential gain, even if this target does not require such high sensing accuracy. Considering this, this embodiment adopts an exponential utility function to represent the sensing performance for UAVs with different QoS requirements.

Specifically, without loss of generality, FIM using dₖ is taken as the sensing performance indicator for the k-th UAV, which is expressed as:

$${ξ}_{k} = {J}_{k} ( 1 , 1 ) . \qquad ( 11 )$$

If AoA and ZoA need to be considered, it can be extended to a weighted FIM with three parameters. The global positioning performance (i.e., the first global positioning performance) of all UAVs can be expressed as:

$$ϕ = - {\sum }_{k = 1}^{K} exp ( 1 - \frac{{ξ}_{k}}{{η}_{k}} ) , \qquad ( 12 )$$

wherein ηₖ represents the expected positioning CRLB of the k-th UAV. Due to the characteristic of the exponential utility function, the growth rate of the function φ when the variable ξₖ is greater than ηₖ is much slower than that when the variable ξₖ is less than ηₖ. This characteristic indicates that allocating resources to UAV that has not yet achieved the expected sensing performance will generate a higher return.

Therefore, the first optimization objective in the optimization problem may be modeled as maximizing the first global positioning performance, which is expressed as:

$$OP : {max}_{P , G} ϕ .$$

Optionally, generating the first optimization constraint condition for resource allocation optimization in the active sensing mode according to the downlink communication signals received by the communication user from the base stations and the beam power allocation information of the base stations includes:
obtaining a first SINR for reception of the communication user according to the downlink communication signals received by the communication user from the base stations;
   wherein specifically, according to the above formulas (1) to (3), the SINR of the m-th UE is:

$${SINR}_{m} = \frac{{\sum }_{n = 1}^{N} {\tilde{o}}^{2} {α}_{m , n} {p}_{m , n} {g}_{m , n} {‖ {a}_{{N}_{t}}^{H} ( {φ}_{m , n} , {θ}_{m , n} ) {f}_{m , n} ‖}^{2}}{\begin{matrix}{\sum }_{n = 1}^{N} {\sum }_{i \neq n , i ∈ M} {\tilde{o}}^{2} {α}_{m , n} {p}_{i , n} {g}_{i , n} {‖ {a}_{{N}_{t}}^{H} ( {φ}_{m , n} , {θ}_{m , n} ) {f}_{i , n} ‖}^{2} + \\ {\sum }_{n = 1}^{N} {\sum }_{k}^{K} {\tilde{o}}^{2} {α}_{m , n} {p}_{k , n} {g}_{k , n} {‖ {a}_{{N}_{t}}^{H} ( {φ}_{m , n} , {θ}_{m , n} ) {f}_{k , n} ‖}^{2} + {σ}_{d}^{2}\end{matrix}} ¶ , \qquad ( 13 )$$

taking the first SINR being greater than or equal to a first preset SINR threshold as a first condition, wherein the resource constraint information includes the first preset SINR threshold, the first condition is expressed as follows:

$${SINR}_{m} \geq {γ}_{m} , m = 1 , 2 , … , M ,$$

wherein, γₘ represents the receiving SINR threshold (i.e., first preset power threshold) of the m-th UE;
obtaining a transmission power of each of the base stations and the number of beams supported by each of the base stations according to power allocation information of the base stations and the beam power allocation information of the base stations;
taking the transmission power of each of the base stations being less than or equal to the first preset power threshold as a second condition, wherein the second condition is expressed as follows:

$${\sum }_{j = 1}^{J} {p}_{j , n} {g}_{j , n} \leq {P}_{max} \text{?} , n = 1 , 2 , … , N ,$$

$$\text{?} \text{indicates text missing or illegible when filed}$$

wherein, P=[p₁, p₂, . . . , pₙ]^{T} is the power allocation matrix (i.e., the beam power allocation information of the base stations), Pₙ=[p_{1,n}, p_{2,n}, . . . , p_{j,n}]^{T} is the beam power allocation vector of the n-th base station, where p_{j,n} represents power allocated by the n-th base station to the j-th beam; G=[g₁, g₂, . . . gₙ]^{T} is the beam selection matrix, and g_{j,n} represents the equivalent channel gain (or beamforming gain) for the j-th beam at the n-th base station;

$${P}_{max}^{n}$$

is the maximum transmission power (i.e., the first preset power threshold) of the n-th base station, wherein the resource constraint information includes the maximum transmission power of the base station;
taking the number of beams supported by each of the base stations being less than or equal to a first preset number as a third condition, wherein the third condition is expressed as follows:

$${\sum }_{j = 1}^{J} {g}_{j , n} \leq {B}_{max} \text{?} , n = 1 , 2 , … , N ,$$

$$\text{?} \text{indicates text missing or illegible when filed}$$

wherein, G=[g₁, g₂, . . . gₙ]^{T} is the beam selection matrix,

$${B}_{max}^{n}$$

represents the maximum number of beams supported (i.e., the first preset number) by the n-th base station, wherein the resource constraint information includes the maximum number of beams supported by the base station;
generating a fourth condition according to a preset beam selection matrix;
   specifically, the fourth condition is expressed as follows:

$${g}_{j , n} ∈ \{ 0 , 1 \} , ∀ j , n ,$$

wherein, G=[g₁, g₂, . . . gₙ]^{T} is the beam selection matrix,
obtaining the first optimization constraint condition according to the first condition, the second condition, the third condition, and the fourth condition.

In summary, the optimization problem obtained according to the first optimization objective and the first optimization constraint condition is expressed as:

$$: {max}_{P , G} ϕ \qquad ( 14 )$$

$$s . t . {SINR}_{m} \geq {γ}_{m} , m = 1 , 2 , … , M ,$$

$${\sum }_{j = 1}^{J} {p}_{j , n} {g}_{j , n} \leq {P}_{{max}^{( n )}} , n = 1 , 2 , … , N ,$$

$${\sum }_{j = 1}^{J} {g}_{j , n} \leq {B}_{max}^{( n )} , n = 1 , 2 , … , N ,$$

$${p}_{j , n} \geq 0 , ∀ j , n ,$$

$${g}_{j , n} ∈ \{ 0 , 1 \} , ∀ j , n ,$$

wherein P=[p₁, p₂, . . . pₙ]^{T} is the power allocation matrix, Pₙ=[p_{1,n}, p_{2,n}, . . . p_{j,n}]^{T} is the beam power allocation vector of the n-th base station, G=[g₁, g₂, . . . gₙ]^{T} is the beam selection matrix, γₘ represents the receiving SINR threshold of the m-th UE,

$${P}_{max}^{n} and {B}_{max}^{n}$$

represent the maximum transmission power of the n-th base station and the maximum number of beams supported by the n-th base station respectively.

Optionally, performing resource allocation optimization on the second multi-base station collaborative ISAC system in the active sensing mode according to the first optimization objective and the first optimization constraint condition to obtain the second resource allocation information in the active sensing mode includes:
performing approximate convex relaxation processing on the fourth condition in the first optimization constraint condition to obtain a fifth condition,
   specifically, directly solving the optimization problem is challenging due to the coupling and discontinuity of the optimization variables. Therefore, first, approximate convex relaxation is performed by replacing g_{j,n}∈{0, 1} with the inequality constraint 0≤g_{j,n}≤1;
decomposing the first optimization objective into a first sub-objective and a second sub-objective using an initial beam selection matrix. Specifically, decomposing the original optimization problem into two sub-problems, alternately optimizing P and G, wherein the first sub-objective is to maximize P, and the second sub-objective is to maximize G;
obtaining numerator information and denominator information in the first SINR for reception of the communication user according to an initial beam selection matrix,
   wherein, through the initial beam selection matrix G (initialized as an all-ones matrix), aₘ(p) and bₘ(p) are used to represent the numerator and denominator in the expression of SINR for reception of UE, which is a function of p;
converting the first condition in the first optimization constraint condition into a sixth condition according to the numerator information and the denominator information. Specifically, the sixth condition is expressed as follows:

$${a}_{m} ( p ) \geq {γ}_{m} {b}_{m} ( p ) , m = 1 , … , M ,$$

generating a first optimization problem according to the first sub-objective, the sixth condition, and the second condition in the first optimization constraint condition,
   that is, the original optimization problem may be written as sub-problem 1 (i.e., the first optimization problem), as follows:

$$OP 1 : {max}_{P} ϕ \qquad ( 15 )$$

$$s . t . {a}_{m} ( p ) \geq {γ}_{m} {b}_{m} ( p ) , m = 1 , … , M ,$$

$${\sum }_{j = 1}^{J} {p}_{j , n} {g}_{j , n} \leq {P}_{{max}^{( n )}} , n = 1 , … , N ,$$

$${P}_{j , n} \geq 0 , ∀ j , n ,$$

generating a second optimization problem according to the second sub-objective, the sixth condition, the third condition in the first optimization constraint condition, and the fifth condition;
   sub-problem 2 related to the beam selection matrix (i.e., the second optimization problem) is as follows:

$$2 : {max}_{G} ϕ \qquad ( 16 )$$

$$s . t . {a}_{m} ( g ) \geq {γ}_{m} {b}_{m} ( g ) , m = 1 , 2 , … , M ,$$

$${\sum }_{j = 1}^{J} {g}_{j , n} \leq {B}_{max}^{( n )} , n = 1 , 2 , … , N ,$$

$$0 \leq {g}_{j , n} \leq 1 , ∀ j , n ,$$

wherein aₘ(g) and bₘ(g) represents the numerator and denominator in the expression of SINR for UE, which is a function of g.
obtaining the second resource allocation information in the active sensing mode by alternately solving the first optimization problem and the second optimization problem.

Sub-problem 1 is a convex problem and may be solved by a convex optimization solver. Then, the optimization result P* is taken as a fixed variable in the original optimization problem, to obtain sub-problem 2 regarding the beam selection matrix. Similarly, sub-problem 2 is convex and may be solved by a convex optimization solver. Then, the optimization result G* is used as a fixed variable to continue solving sub-problem 1. By alternately solving the two sub-problems, convergence of the objective function is ultimately enabled. The resource allocation information in the converged system is the second resource allocation information in the active sensing mode.

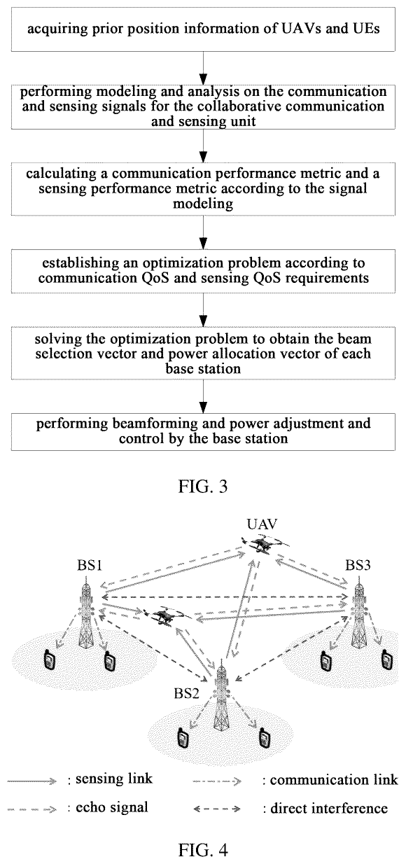

Below, with reference to FIG. 3, the process of acquiring resource allocation information in the active sensing mode provided by the embodiment of the present invention is specifically described:
acquiring prior position information of UAVs and UE, performing modeling and analysis on the communication and sensing signals for the collaborative communication and sensing unit, calculating a communication performance metric and a sensing performance metric according to the signal modeling, establishing an optimization problem according to communication QoS and sensing QoS requirements, solving the optimization problem to obtain the beam selection vector and power allocation vector of each base station, and performing beamforming and power adjustment and control by the base station.

For this mode, the embodiment of the present invention models the relationship between downlink communication signals and active sensing echo signals and transmitting beams of the base stations in a multi-base station collaboration scenario, and derives the SINR expression for a ground communication user and the CRLB of the sensing performance for UAV. By minimizing the CRLB, the sensing accuracy is improved when the location of the UAV is approximately known.

In terms of resource allocation optimization, in order to solve the problem of excessive concentration of resources on a single target caused by traditional methods, the embodiment of the present invention designs a global sensing performance evaluation function based on an exponential utility function for multiple UAV targets with different sensing QoS requirements. Taking this as the optimization objective, an optimization problem is constructed by combining the base station beam capacity, transmission power constraints, and ground user communication QoS requirements. The optimization problem is decomposed into two sub-optimization problems through the approximate convex relaxation method, and an alternating iterative algorithm is used for solving the two sub-optimization problems, ultimately achieving efficient bean and power allocation with multi-base station collaboration.

By reasonably allocating resources, the sensing performance is significantly improved while taking into account multi-target requirements, and the transmission power of base stations is reduced.

In an optional embodiment, the process of acquiring communication and sensing related information in the collaborative sensing mode is specifically described:

as shown in FIG. 4, in the considered collaborative sensing mode, the ISAC scenario consists of J synchronous base stations, K communication users (CUs), and I UAV sensing targets, denoted as [symbol] ={1, 2, . . . , J}, [symbol] ={1, 2, . . . , K}; and [symbol] ={1, 2, . . . , I}. Each BS is equipped with one UPA, with the transmitting antenna array configured as Mₜ=Mₜₓ×M_{ty} and the receiving antenna array configured as Mᵣ=Mᵣₓ×M_{ry}. To achieve capability of ISAC, each BS can communicate with multiple CUs and sense multiple targets simultaneously. Additionally, it is assumed that each CU is pre-assigned to a relevant BS. [symbol] ⱼ={1, 2, . . . , Kⱼ} denote a set of CUs associated with BSj, and kⱼ denote the k-th CU associated with BSj. For sensing target scheduling, a binary target scheduling variable (i.e., target scheduling matrix, which is preset) a_{j,i}∈{0, 1} is defined. If aⱼ, i=1, it means BS j receives and processes the reflection signal from sensing target i; if aⱼ, i=0, it means BS j does not receive and process the reflection signal form sensing target i.

In an optional embodiment, acquiring the second resource allocation information of the second multi-base station collaborative ISAC system includes:
acquiring a transmission signal of a first base station in the second multi-base station collaborative ISAC system, a reception signal of a first communication user communicating with the first base station, and a reflection signal received by the first base station in a collaborative sensing mode; wherein the first base station is any base station in the second multi-base station collaborative ISAC system, and the first communication user is any communication user communicating with the first base station;
   first, for the downlink signal model of the base station, the transmission signal of BS j (i.e., the first base station) can be expressed as:

$${x}_{{j}^{′}} = {W}_{{j}^{′}} {s}_{{j}^{′}} , \qquad ( 17 )$$

$$wherein {W}_{{j}^{′}} = [ {w}_{{j}^{′} , 1} , {w}_{{j}^{′} , 2} , … , {w}_{{j}^{′} , {K}_{{j}^{′}}} ] ∈ {ℂ}^{{M}_{t} \times {K}_{{j}^{′}}} .$$

represents the transmission beamforming matrix (which is preset) of BS j for its served communication users,

$${s}_{{j}^{′}} = {[ {s}_{{j}^{′} , 1} , … , {s}_{{j}^{′} , {K}_{{j}^{′}}} ]}^{T} ∈ {ℂ}^{{K}_{{j}^{′}} \times 1} .$$

represents the communication symbol vector. Without loss of generality, it is assumed that communication symbols from different CUs and for are uncorrelated, that is, for communication user

$${k}_{{j}^{′}} ∈ , 𝔼 [ {\vert {s}_{{j}^{′} , {k}_{{j}^{′}}} \vert}^{2} ] = 1.$$

and for other communication users [symbol] ∈ [symbol] , [symbol] ≠k_{j′}, [symbol] [s_{j′,k}_{_{j′}} [symbol] ]=0.
Therefore, based on the signal model shown in the above formula (17), the reception signal model of CU k_{j′} (i.e., the first communication user) communicating with BS j′ can be constructed and expressed as the following formula (18):

$${y}_{{k}_{{j}^{′}}} = {h}_{{j}^{′} , {k}_{{j}^{′}}}^{H} , {w}_{{j}^{′} , {k}_{{j}^{′}}} , {s}_{{j}^{′} , {k}_{{j}^{′}}} + {h}_{{j}^{′} , {k}_{{j}^{′}}}^{H} + {\sum }_{l \neq {j}^{′}}^{J} {\sum }_{{k}_{l} = 1}^{{K}_{l}} {h}_{l , {k}_{{j}^{′}}}^{H} , {w}_{l , {k}_{l}} {s}_{l , {k}_{l}} + {n}_{k} , \qquad ( 18 )$$

wherein,

$${h}_{{j}^{′} , {k}_{{j}^{′}}} ∈ {ℂ}^{{M}_{t}} and {h}_{l , {k}_{j}^{′}} ∈ {ℂ}^{{M}_{t}}$$

represent the communication channels from BS to CU k_{j′}, respectively. The first part of formula (18) is the desired communication signal from BS j′ to CU k_{j′}, the second part of formula (18) is intra-cell interference from other CUs, the third part of formula (18) is inter-cell interference from other BSs. The last part of formula (18) is the additive white Gaussian noise (AWGN) at the CU k_{j′} receiving end, wherein

$${n}_{k} \sim 𝒞𝒩 ( 0 , {σ}_{n}^{2} )$$

representing the AWGN with variance

$${σ}_{n}^{2}$$

Considering that the movement speed of UAV target is generally low, and the change in the motion state of the sensing target is relatively small compared to the transmission and processing capability of the sensing signal, the accurate direction for the target can be estimated in advance to design the transmission signal for detecting the target. Then the reflection signal received by BS j can be expressed as:

$${y}_{j} = {\sum }_{{j}^{′} = 1}^{J} {\sum }_{i = 1}^{I} {β}_{{j}^{′} , j , i} {a}_{r} ( {ϕ}_{j , i} , {θ}_{j , i} ) {a}_{t}^{H} ( {φ}_{{j}^{′} , i} , {ϑ}_{{j}^{′} , i} ) {x}_{{j}^{′}} + {\sum }_{{j}^{′} = 1}^{J} {G}_{{j}^{′} , j}^{H} {x}_{{j}^{′}} + {n}_{r} , \qquad ( 19 )$$

$${a}_{r} ( {ϕ}_{j , i} , {θ}_{j , i} ) = {[ 1 , … , {e}^{j 2 π sin {θ}_{j , i} ( {m}_{tx} , cos {ϕ}_{j , i} + {m}_{ty} sin {ϕ}_{j , i} )} , … , \\ {e}^{j 2 π sin {θ}_{j , i} ( {M}_{tx} cos {ϕ}_{j , i} + {M}_{ty} sin {ϕ}_{j , i} )} ]}^{H}$$

$${a}_{t} ( {φ}_{{j}^{′} , i} , {ϑ}_{{j}^{′} , i} ) = {[ 1 , … , {e}^{j 2 π sin {θ}_{{j}^{′} , i} ( {m}_{tx} , cos {φ}_{{j}^{′} , i} + {m}_{ty} sin {φ}_{{j}^{′} , i} )} , … , \\ {e}^{j 2 π sin {ϑ}_{{j}^{′} , i} ( {M}_{tx} cos {φ}_{{j}^{′} , i} + {M}_{ty} sin {φ}_{{j}^{′} , i} )} ]}^{H}$$

wherein, φ_{j,i} represents the azimuth angle of arrival of a reflected signal from the target i for the reception base station j; θ_{j,i} represents the zenith angle of arrival of a reflected signal from the target i for the reception base station j; φ_{j′,i} represents the azimuth angle of a transmitting signal of the transmitting base station j′ for the target i; θ_{j′,i} represents the zenith angle of a transmitting signal of the transmitting base station j′ for the target i; nᵣ is a reception noise for the receiving BS j,

$${n}_{r} \sim 𝒞𝒩 ( 0 , {σ}_{n}^{2} ) .$$

$${G}_{{j}^{′} , j} ∈ {ℂ}^{{M}_{t} \times M} \text{?}$$

$$\text{?} \text{indicates text missing or illegible when filed}$$

represents a direct channel from BS j′ to BS j. If j′≠j, then

$${G}_{j}^{′} , j = 1 ,$$

otherwise

$${G}_{j}^{′} , j$$

is 0. β_{j′,j,i} is a reflection coefficient from the transmitting BS j′ to the receiving BS j via the sensing target, including a round-trip path loss and radar cross section (RCS) σ_{rcs}. According to the radar equation, formula (20) is obtained:

$${β}_{{j}^{′} , j , i} = \sqrt{\frac{{λ}^{2} {σ}_{rcs}}{{( 4 π )}^{3} {d}_{1}^{2} {d}_{2}^{2}}} , \qquad ( 20 )$$

wherein, λ represents a wavelength, d₁ and d₂ represent a distance from a transmitting BS to a sensing target and a distance from the sensing target to a receiving BS, respectively. Assuming an antenna spacing of a BS is half of the wavelength, response vectors of the antenna array to the azimuth angle and pitch angle are respectively expressed as:

$${a}_{r} ( {ϕ}_{j , i} , {θ}_{j , i} ) = {[ 1 , ... , {e}^{j 2 {π sin θ}_{j , i}} ( m \text{?} cos {ϕ}_{j , i} + m \text{?} sin {ϕ}_{j , i} ) , ... , {e}^{j 2 {π sin θ}_{j , i}} ( M \text{?} cos {ϕ}_{j , i} + M \text{?} sin {ϕ}_{j , i} ]}^{H} \qquad ( 21 )$$

$${a}_{t} ( {φ}_{{j}^{′} , i} , {\text{?}}_{{j}^{′} , i} ) = {[ 1 , ... , {e}^{j 2 {π sin θ}_{{j}^{′} , i}} ( m \text{?} cos {φ}_{{j}^{′} , i} + m \text{?} sin {φ}_{{j}^{′} , i} ) , ... , {e}^{j 2 {π sin θ}_{{j}^{′} , i}} ( M \text{?} cos {φ}_{{j}^{′} , i} + M \text{?} sin {φ}_{{j}^{′} , i} ]}^{H} , \qquad ( 22 )$$

$$\text{?} \text{indicates text missing or illegible when filed}$$

wherein mₜₓ∈[1, Mₜₓ] and m_{ty}∈[1, M_{ty}] are antenna indices.
obtaining a second SINR for the first communication user according to the transmission signal of the first base station and the reception signal of the first communication user;
   according to formulas (17) and (18), it can obtained that the SINR (i.e., the second SINR) of CU k_{j′} communicating with BS j′ can be expressed as:

$${γ}_{{k}_{{j}^{′}}} = \frac{{\vert {h}_{{j}^{′} , {k}_{{j}^{′}}}^{H} {w}_{{j}^{′} , {k}_{{j}^{′}}} \vert}^{2}}{{\text{?}}_{{j}^{′} ,} \text{?} + \text{?} + {σ}_{n}^{2}} \qquad ( 23 )$$

$$\text{?} \text{indicates text missing or illegible when filed}$$

wherein, [symbol] and I_{l,k}_{ₗ} are the intra-cell interference and inter-cell interference, respectively, expressed as:

$$= {\vert {h}_{{j}^{′} , {k}_{{j}^{′}}}^{H} \vert}^{2} \qquad ( 24 )$$

$${I}_{l , {k}_{l}} = {\sum }_{l \neq j} \text{?} \text{?} {\sum }_{{k}_{l} = 1}^{{K}_{l}} {\vert {h}_{l , {k}_{l}}^{H} {w}_{l , {k}_{l}} \vert}^{2} ; \qquad ( 25 )$$

$$\text{?} \text{indicates text missing or illegible when filed}$$

obtaining a third SINR of radar output signal for a sensing target at the first base station according to a reflection signal received by the first base station;
   in the collaborative sensing ISAC scenario, BS j receives sensing signals from multiple BSs and reflected by multiple sensing targets. To capture the desired signal of target i, a reception beamforming filter u_{j,i}∈ [symbol] ^{M}^{ᵣ} is applied to the received sensing signal y. Considering that the premise of sensing is that the reflected signal can be detected, the strength of the sensing signal is usually positively correlated with sensing accuracy and detection probability. Therefore, the SINR of the received sensing signal can be used as a metric of sensing performance.
   Based on the above formula (17), SINR (i.e., the third SINR) of the radar output signal for sensing target i at BS j can be expressed as:

$${γ}_{j , i} = \frac{{a}_{j , i} 𝔼 ( {\vert {\sum }_{{j}^{′} = 1}^{J} {β}_{{j}^{′} , j , i} {u}_{j , i}^{H} {A}_{{j}^{′} , j , i} {x}_{{j}^{′}} \vert}^{2} )}{{Γ}_{j , i}} \qquad ( 26 )$$

wherein,

$${A}_{{j}^{′} , j , i} = {a}_{r} ( {ϕ}_{j , i} , {θ}_{j , i} ) {a}_{t}^{H} ( {φ}_{{j}^{′} , i} , {\text{?}}_{{j}^{′} , i} ) .$$

$$\text{?} \text{indicates text missing or illegible when filed}$$

In formula (26), σ_{j,i} represents the total interference for sensing target i at BS j, which can be expressed as:

$${Γ}_{j , i} = 𝔼 \{ {\vert {{\sum }_{{j}^{′} = 1}}^{J} {u}_{j , i}^{H} {G}_{{j}^{′} , j}^{H} {x}_{{j}^{′}} \vert}^{2} \} + 𝔼 \{ {\vert {u}_{j , i}^{H} {n}_{r} \vert}^{2} \} ¶ \qquad ( 27 )$$

$$𝔼 \{ {\vert {\sum }_{{i}^{′} \neq i}^{I} {\sum }_{{j}^{′} = 1}^{J} {β}_{{j}^{′} , j , {i}^{′}} {u}_{j , i}^{H} {A}_{{j}^{′} , j , {i}^{′}} {x}_{{j}^{′}} \vert}^{2} \} ,$$

wherein, the first term represents a direct interference signal from other base stations, the second term is a noise, and the third term is an interference signal from other sensing targets.
generating a second optimization objective according to the second SINR. Under the max-min fairness principle, SINR of the sensing signal of the receiving base station is maximized, i.e., maximizing the second SINR as the second optimization objective, expressed as:

$$P 1 : {max}_{{α}_{j , i} , {w}_{{j}^{′}} , {k}_{{j}^{′}} , {u}_{j , i}} {min}_{i ∈ 𝒥} {γ}_{j , i} ; \qquad ( 28 )$$

generating a second optimization constraint condition for resource allocation optimization in the collaborative sensing mode according to the third SINR and power budget information of the first base station, wherein the second optimization constraint condition is to satisfy the communication SINR of the communication users and the power budget constraint of the base station;
performing resource allocation optimization on the second multi-base station collaborative ISAC system in the collaborative sensing mode according to the second optimization objective and the second optimization constraint condition to obtain the second resource allocation information in the collaborative sensing mode.

Optionally, generating the second optimization constraint condition for resource allocation optimization in the collaborative sensing mode according to the third SINR and the power budget information of the first base station includes:
taking the third SINR being greater than or equal to a second preset SINR threshold as a seventh condition, expressed as:

$${γ}_{{k}_{{j}^{′}}} \geq {γ}_{min} ∀ {j}^{′} ∈ 𝒥 , {k}_{{j}^{′}} ∈ {𝒦}_{{j}^{′}} , \qquad ( 29 )$$

wherein, γₘᵢₙ is the minimum SINR threshold required by the communication user, i.e., the second preset SINR threshold. The resource constraint information includes the minimum SINR threshold required by the communication user;
taking a transmission power of the first base station is less than or equal to a second preset power threshold indicated by the power budget information of the first base station as an eighth condition, expressed as:

$${\sum }_{{k}_{{j}^{′}} = 1}^{{K}_{{j}^{′}}} {‖ {w}_{{j}^{′} , {k}_{{j}^{′}}} ‖}^{2} \leq {P}_{0} ∀ {j}^{′} ∈ 𝒥 , {k}_{{j}^{′}} ∈ {𝒦}_{{j}^{′}} , \qquad ( 30 )$$

wherein,

$$\{ {w}_{{j}^{′} , {k}_{j}^{′}} \} {j}^{′} ∈ 𝒥 , {k}_{{j}^{′}} ∈ {𝒦}_{{j}^{′}}$$

is the transmission beamforming matrix of the base station, i.e., the transmission power of the first base station, P₀ is a maximum transmission power of each base station, i.e., the second preset power threshold. The resource constraint information includes the maximum transmission power of each base station;
generating a ninth condition according to a preset target scheduling matrix, expressed as:

$${a}_{j , i} ∈ \{ 0 , 1 \} {\sum }_{j = 1}^{J} {a}_{j , i} = 1 ∀ j ∈ 𝒥 , i ∈ 𝒥 ; \qquad ( 31 )$$

obtaining the second optimization constraint condition according to the seventh condition, the eighth condition, and the ninth condition.

Under the max-min fairness principle, SINR of the sensing signal at the receiving base station is maximized, while satisfying both the communication SINR of the communication users and the power budget constraints of the base stations. This problem is formulated as a joint optimization problem for the target scheduling variable a_{j,i}, the base station transmission beamforming matrix

$${\{ {w}_{{j}^{′} , {k}_{j}^{′}} \}}_{{j}^{′} ∈ 𝒥 , {k}_{{j}^{′}} ∈ {𝒦}_{{j}^{′}}} ,$$

and the reception beamforming vector (reception beamforming matrix) [symbol] , specifically as follows:

$$P 1 : {max}_{{a}_{j , i} {w}_{{j}^{′} , {k}_{{j}^{′}}} {u}_{j , i}} {min}_{i ∈ 𝒥} ∈ {γ}_{j , i}$$

$$s . t . {γ}_{{k}_{{\text{?}}^{′}}} \geq {γ}_{min} ∀ {j}^{′} ∈ 𝒥 , {k}_{{j}^{′}} ∈ {𝒦}_{{j}^{′}}$$

$${\sum }_{{k}_{{i}^{′}} = 1}^{{K}_{{j}^{′}}} {‖ {w}_{{j}^{′} , {k}_{{j}^{′}}} ‖}^{2} \leq {P}_{0} ∀ {j}^{′} ∈ 𝒥 , {k}_{{j}^{′}} ∈ {𝒦}_{{j}^{′}}$$

$${a}_{j , i} ∈ \{ 0 , 1 \} {\sum }_{j = 1}^{J} {a}_{j , i} = 1 ∀ j ∈ 𝒥 , i ∈ 𝒥 ,$$

$$\text{?} \text{indicates text missing or illegible when filed}$$

wherein, γₘᵢₙ is the minimum SINR threshold required by the communication user, and P₀ is the maximum transmission power of each base station.

Due to the multiplication of the beamforming matrix and the target scheduling matrix in the objective function, the optimization problem is a non-convex mixed integer program. Furthermore, the fractional structure of the objective function also leads to a non-convex optimization problem, making it difficult to solve. Therefore, the original problem needs to be transformed. The transformation of the original problem includes the following steps.

That is, optionally, performing resource allocation optimization on the second multi-base station collaborative ISAC system in the collaborative sensing mode according to the second optimization objective and the second optimization constraint condition to obtain the second resource allocation information in the collaborative sensing mode includes:
converting the second optimization objective into a third optimization problem according to a transmission beamforming matrix and a target scheduling matrix;
solving the third optimization problem by using generalized Rayleigh entropy to obtain an optimized reception beamforming matrix;
   Specifically, it is the reception beamforming optimization problem: in this sub-problem, given the transmission beamforming matrix and the target scheduling matrix, then, the original problem depends only on u_{j,i}. And the transformed problem i.e., the third optimization problem, can be solved via the generalized Rayleigh entropy; converting the second optimization objective into a third sub-objective by a Dinkelbach method;
obtaining a fourth optimization problem according to the third sub-objective, the sixth condition and the seventh condition in the second optimization constraint condition;
solving the fourth optimization problem to obtain an optimized transmission beamforming matrix;
   Specifically, it is the transmission beamforming optimization problem: in this sub-problem i.e., the fourth optimization problem, first, the fractional structure of the original problem is transformed using the Dinkelbach method, and then the optimal transmission beamforming matrix is obtained using the Lagrangian dual method.
optimizing the target scheduling matrix according to the optimized reception beamforming matrix, the optimized transmission beamforming matrix, and the second optimization objective to obtain the second resource allocation information in the collaborative sensing mode.

That is, it is the target scheduling optimization problem: the target scheduling variables are optimized according to the highest SINR based on the optimized transmit and reception beamforming variables.

The reception beamforming optimization sub-problem is specifically described below:

Given the transmission beamforming matrix and the target scheduling matrix, the reception beamforming matrix depends only on the target. Therefore, the reception beamforming matrix is optimized by the following optimization criterion:

$$P 2 : {max}_{{u}_{j , i}} {min}_{i ∈ 𝒥} \frac{{u}_{j , i}^{H} ( {\sum }_{{j}^{′} = 1}^{J} {β}_{{j}^{′} , j , i}^{2} {A}_{{j}^{′} , j , i} {QA}_{{j}^{′} , j , i}^{H} ) {u}_{j , i}}{{u}_{j , i}^{H} B {u}_{j , i}} , \qquad ( 32 )$$

wherein B represents the direct channel interference from other base stations and other targets, and Q represents the covariance matrix of the downlink ISAC signal, which can be expressed as:

$$B = {\sum }_{{i}^{′} \neq i}^{I} {\sum }_{{j}^{′} = 1}^{J} {β}_{{j}^{′} , j , {i}^{′}}^{2} {A}_{{j}^{′} , j , {i}^{′}} {QA}_{{j}^{′} , j , {i}^{′}}^{H} + {\sum }_{{j}^{′} = 1}^{J} {G}_{{j}^{′} , j}^{H} {QG}_{{j}^{′} , j} + {σ}_{n}^{2} {I}_{{M}_{r}} \qquad ( 33 )$$

$$Q = E \{ \vert {x}_{{j}^{′}} {x}_{{j}^{′}}^{H} \vert \} = {\sum }_{{k}_{{j}^{′}} = 1}^{{K}_{{j}^{′}}} {w}_{{j}^{′} , {k}_{{j}^{′}}} {w}_{{j}^{′} , {k}_{{j}^{′}}}^{H} . \qquad ( 34 )$$

From the expression of formula (32), the sub-problem maximizes the minimum sensing signal-to-noise ratio among targets, thereby obtaining the optimal reception beamforming solution. With the fixed transmission beamforming and the fixed target scheduling, the optimization of u_{j,i} for target i does not affect the performance of other targets. Therefore, the optimization of u_{j,i} for each target can be performed separately. Based on this, formula (32) for the max-min optimization problem is equivalent to the following problem:

$${max}_{{u}_{j , i}} \frac{{u}_{j , i}^{H} ( {\sum }_{{j}^{′} = 1}^{J} {β}_{{j}^{′} , j , i}^{2} {A}_{{j}^{′} , j , i} Q {A}_{{j}^{′} , j , i}^{H} ) {u}_{j , i}}{{u}_{j , i}^{H} B {u}_{j , i}} ∀ i ∈ 𝒥 . \qquad ( 35 )$$

The transformed problem formula (32) is a generalized Rayleigh entropy, and the optimal solution for

$${u}_{j , i}^{*}$$

can be obtained as:

$${u}_{j , i}^{*} = {V}_{max} ( {B}^{- 1} ( {\sum }_{{j}^{′} = 1}^{j} {β}_{{j}^{′} , j , i}^{2} {A}_{{j}^{′} , j , i} {QA}_{{j}^{′} , j , i}^{H} ) ) , \qquad ( 36 )$$

wherein, Vₘₐₓ(H) represents the eigenvector corresponding to the largest eigenvalue of matrix H.

Transmission beamforming optimization sub-problem:

Since a_{j,i} is an integer variable with value 0 or 1, a_{j,i} is first relaxed to a continuous variable a_{j,i}∈[0, 1]. Given the optimal reception beamforming matrix and target scheduling variables, the transmission beamforming sub-problem can be expressed as:

$$P3 : {max}_{{w}_{{j}^{′} , {k}_{{j}^{′}}}} {min}_{i ∈ 𝒥} \frac{{a}_{j , i} {\sum }_{{j}^{′} = 1}^{J} {\sum }_{{k}_{{j}^{′}} = 1}^{{k}_{{j}^{′}}} {β}_{{j}^{′} , j , i}^{2} {w}_{{j}^{′} , {k}_{{j}^{′}}}^{H} {C}_{j , i} {w}_{{j}^{′} , {k}_{{j}^{′}}}}{{\sum }_{{j}^{′} = 1}^{J} {\sum }_{{k}_{{j}^{′}} = 1}^{{K}_{{j}^{′}}} {w}_{{j}^{′} , {k}_{{j}^{′}}}^{H} {D}_{j , i} {w}_{{j}^{′} , {k}_{{j}^{′}}} + {E}_{j , i}} \qquad ( 37 )$$

$$s . t . {γ}_{{k}_{{j}^{′}}} \geq {γ}_{min} ∀ {j}^{′} ∈ 𝒥 , {k}_{{j}^{′}} ∈ {𝒦}_{{j}^{′}} \qquad ( 38 )$$

$${\sum }_{{k}_{{j}^{′}} = 1}^{{K}_{{j}^{′}}} {‖ {w}_{{j}^{′} , {k}_{{j}^{′}}} ‖}^{2} \leq {P}_{0} ∀ {j}^{′} ∈ 𝒥 , {k}_{{j}^{′}} ∈ {𝒦}_{{j}^{′}} , \qquad ( 39 )$$

wherein, C_{j,i}, D_{j,i}, E_{j,i} can be expressed as follows:

$${C}_{j , i} = {A}_{{j}^{′} , j , i}^{H} {u}_{j , i} {u}_{j , i}^{H} {A}_{{j}^{′} , j , i} \qquad ( 40 )$$

$${D}_{j , i} = {G}_{{j}^{′} , j} {u}_{ji} {u}_{ji}^{H} {G}_{{j}^{′} , j}^{H} + {\sum }_{{i}^{′} \neq i} {β}_{{j}^{′} , j , {i}^{′}}^{2} {A}_{{j}^{′} , j , {i}^{′}}^{H} {u}_{{j}_{,} i} {u}_{j , i}^{H} {A}_{{j}^{′} , j , {i}^{′}} \qquad ( 41 )$$

$${E}_{j , i} = {u}_{j , i}^{H} {σ}_{n}^{2} {I}_{{M}_{r}} {u}_{j , i} \qquad ( 42 )$$

It can be seen that sub-problem P3 is a quadratic problem with respect to the transmission beamforming

$${w}_{{j}^{′} , {k}_{{j}^{′}}} , {j}^{′} ∈ 𝒥 .$$

The fractional structure of the objective function leads to a non-convex problem, which is difficult to be solved directly. Inspired by the Dinkelbach method, the non-convexity of sub-problem P3 can be transformed into a solvable problem. The optimal solution of sub-problem P3 can be obtained if and only if the following equation is satisfied:

$${max}_{{w}_{{j}^{′} , {k}_{{j}^{′}}}} {min}_{i ∈ 𝒥} {a}_{j , i} ( {f}_{N} ( {w}_{{j}^{′} , {k}_{{j}^{′}}} ) - {η}^{*} {f}_{D} ( {f}_{N} ( {w}_{{j}^{′} , {k}_{{j}^{′}}} ) ) = {min}_{i ∈ 𝒥} {a}_{j , i} ( {f}_{N} ( {w}_{{j}^{′} , {k}_{{j}^{′}}}^{*} ) - {η}^{*} {f}_{D} ( {f}_{N} ( {w}_{{j}^{′} , {k}_{{j}^{′}}}^{*} ) ) = 0 , \qquad ( 43 )$$

wherein, η* is the optimal non-negative parameter, representing the optimal value of parameter η at convergence and obtained by equation (43), and

$${f}_{N} ( {w}_{{j}^{′} , {k}_{{j}^{′}}} ) and {f}_{D} ( {w}_{{j}^{′} , {k}_{{j}^{′}}} )$$

represent the numerator and denominator of the objective function in P3, respectively.

$${f}_{N} ( {a}_{j , i} {w}_{{j}^{′} , {k}_{{j}^{′}}} ) = {\sum }_{{j}^{′} = 1}^{J} {\sum }_{{k}_{{j}^{′}} = 1}^{{K}_{{j}^{′}}} {β}_{{j}^{′} , j , i}^{2} {w}_{{j}^{′} , {k}_{{j}^{′}}}^{H} {C}_{j , i} {w}_{{j}^{′} , {k}_{{j}^{′}}} \qquad ( 44 )$$

$${f}_{D} ( {w}_{{j}^{′} , {k}_{{j}^{′}}} ) = {\sum }_{{j}^{′} = 1}^{J} {\sum }_{{k}_{{j}^{′}} = 1}^{{K}_{{j}^{′}}} {w}_{{j}^{′} , {k}_{{j}^{′}}}^{H} {D}_{j , i} {w}_{{j}^{′} , {k}_{j}} + {E}_{j , i} . \qquad ( 45 )$$

The proof of the above conclusion can be derived from generalized fractional programming theory. Therefore, problem P3 can be transformed into the following problem:

$$P 4 : {max}_{{w}_{{j}^{′} , {k}_{{j}^{′}}}} {min}_{i ∈ 𝒥} {a}_{j , i} ( {f}_{N} ( {w}_{{j}^{′} , {k}_{{j}^{′}}} ) - η {f}_{D} ( {w}_{{j}^{′} , {k}_{{j}^{′}}} ) ) \qquad ( 46 )$$

$$s . t . ( 38 ) , ( 39 )$$

By introducing an auxiliary variable γ, problem P4 can be transformed into:

$$P 5 : {min}_{{w}_{{j}^{′} , {k}_{{j}^{′}} , γ}} - γ \qquad ( 47 )$$

$$s . t . {a}_{j , i} ( {f}_{n} ( {w}_{{j}^{′} , {k}_{{j}^{′}}} ) - η {f}_{D} ( {w}_{{j}^{′} , {k}_{{j}^{′}}} ) ) \geq γ ∀ i ∈ 𝒥 , j ∈ 𝒥 \qquad ( 48 )$$

$$( 38 ) , ( 39 )$$

Although P5 is more solvable, it is still a non-convex quadratic problem. To obtain the optimal solution, the Lagrangian dual method is used to analyze the optimal solution of problem P5, which possesses some strong duality conditions. The Lagrangian function can be expressed as:

$$L ( γ , {w}_{{j}^{′} , {k}_{{j}^{′}}} , δ , α , ζ ) = {\sum }_{\text{?}}^{\text{?}} {\sum }_{\text{?}}^{\text{?}} \text{?} ( γ - \text{?} {\sum }_{\text{?}}^{\text{?}} {\sum }_{\text{?}}^{\text{?}} {β}_{\text{?}}^{2} {w}_{\text{?}}^{H} {C}_{\text{?}} {w}_{\text{?}} + \text{?} ( {\sum }_{\text{?}}^{\text{?}} {\sum }_{\text{?}}^{\text{?}} {w}_{\text{?}} {D}_{\text{?}} {w}_{\text{?}} + {u}_{\text{?}}^{\text{?}} {σ}_{\text{?}}^{\text{?}} {\text{?}}_{\text{?}} {u}_{\text{?}} ) ) + {\sum }_{\text{?}}^{\text{?}} {\sum }_{\text{?}}^{\text{?}} {α}_{\text{?}} ( {σ}_{\text{?}}^{2} + {\sum }_{\text{?}}^{\text{?}} {\sum }_{\text{?}}^{\text{?}} {w}_{\text{?}}^{\text{?}} {h}_{\text{?}} {h}_{\text{?}}^{\text{?}} {w}_{\text{?}} - \frac{{w}_{\text{?}}^{\text{?}} {h}_{\text{?}} {h}_{\text{?}}^{\text{?}} {w}_{\text{?}}}{\text{?}} ) + {\sum }_{\text{?}}^{\text{?}} \text{?} ( {\sum }_{\text{?}}^{\text{?}} {w}_{\text{?}}^{\text{?}} {w}_{\text{?}} - {P}_{\text{?}} ) - γ = {\sum }_{\text{?}}^{\text{?}} {\sum }_{\text{?}}^{\text{?}} {w}_{\text{?}}^{\text{?}} \text{?} + ( {\sum }_{\text{?}}^{\text{?}} {\sum }_{\text{?}}^{\text{?}} {δ}_{\text{?}} - 1 ) γ + {\sum }_{\text{?}}^{\text{?}} {\sum }_{\text{?}}^{\text{?}} \text{?} {σ}_{\text{?}}^{\text{?}} - {\sum }_{\text{?}}^{\text{?}} \text{?} {P}_{\text{?}} + {\sum }_{\text{?}}^{\text{?}} {\sum }_{\text{?}}^{\text{?}} {δ}_{\text{?}} {a}_{\text{?}} η {u}_{\text{?}}^{\text{?}} {σ}_{\text{?}}^{2} {\text{?}}_{\text{?}} {u}_{\text{?}} \qquad ( 49 )$$

$$wherein , δ = {\{ {δ}_{j , i} \}}_{j ∈ J , i ∈ I} , α = {\{ {α}_{{j}^{′} , {k}_{{j}^{′}}} \}}_{{j}^{′} ∈ J , {k}_{{j}^{′}} ∈ {K}_{j}} and ζ = {\{ {ζ}_{{j}^{′}} \}}_{{j}^{′} ∈ J}$$

$$\text{?} \text{indicates text missing or illegible when filed}$$

are dual variables.

Π is expressed as:

$$Π = - {{\sum }^{J}}_{j = 1} {{{\sum }^{I}}_{i = 1}}_{} {δ}_{j , i} {a}_{j , i} {β}_{{j}^{′} , j , i}^{2} {c}_{j , i} + {{\sum }^{J}}_{j = 1} {{\sum }^{{K}_{m}}}_{{k}_{m} = 1} {α}_{m , {k}_{m}} {h}_{{j}^{′} , {k}_{m}} {h}_{{j}^{′} , {k}_{m}}^{H} + {{\sum }^{J}}_{j = 1} {{{\sum }^{I}}_{i = 1}}_{} {δ}_{j , i} {a}_{j , i} η {D}_{j , i} - {a}_{{j}^{′} , {k}_{j}^{′}} ( 1 + \frac{1}{{γ}_{min}} ) {h}_{{j}^{′} , {k}_{j}^{′}} {h}_{{j}^{′} , {k}_{j}^{′}}^{H} + {ζ}_{{j}^{′}} {I}_{{M}_{r}} \qquad ( 50 )$$

Therefore, the dual function is expressed as:

$$g ( δ , α , ζ ) = {inf}_{{w}_{{j}^{′} , {k}_{{j}^{′}}}} ℒ ( Υ , {w}_{{j}^{′} , {k}_{{j}^{′}}} , δ , α , ζ ) \qquad ( 51 )$$

To ensure that the Lagrangian dual function formula (49) is not unbounded, it is clear that Π

[symbol]

$${\sum }_{j = 1}^{J} {\sum }_{i = 1}^{I} {δ}_{j , i} - 1 ≽ 0$$

should be satisfied. Thus, the dual problem is expressed as:

$$P 6 \text{:} {max}_{δ , α , ζ} {\sum }_{{j}^{′} = 1}^{J} {\sum }_{{k}_{{j}^{′}} = 1}^{{K}_{{j}^{′}}} {α}_{{j}^{′} , {k}_{{j}^{′}}} {σ}_{n}^{2} + {\sum }_{j = 1}^{J} {\sum }_{i = 1}^{I} {δ}_{j , i} {a}_{j , i} η {u}_{j , i}^{H} {σ}_{n}^{2} {I}_{{M}_{r}} {u}_{j , i} - {\sum }_{{j}^{′} = 1}^{J} {ζ}_{{j}^{′}} {P}_{0} \qquad ( 52 )$$

$$\begin{matrix}s . t . Π ≽ 0 & ∀ {j}^{′} ∈ J , ∀ {k}_{{j}^{′}} ∈ {K}_{{j}^{′}}\end{matrix} \qquad ( 53 )$$

$${\sum }_{j = 1}^{J} {\sum }_{i = 1}^{I} {δ}_{j , i} - 1 ≽ 0 \qquad ( 54 )$$

For a convex optimization problem, strong duality can be always ensured in the Slater condition, which is however more difficult for a non-convex optimization problem. However, the non-convex problem can also achieve strong duality under certain conditions. The following theorem clarifies the relationship between the existence of a saddle point and strong duality.

The saddle point

$$( {Υ}^{⋆} , {w}_{{j}^{′} , {k}_{{j}^{′}}^{*}} , {δ}^{*} , {α}^{*} , {ζ}^{⋆} )$$

of the Lagrangian function

$$ℒ ( Υ , {w}_{{j}^{′} , {k}_{{j}^{′}}^{′}} δ , α , ζ )$$

should satisfy the following condition:

$$ℒ ( {Υ}^{⋆} , {w}_{{j}^{′} , {k}_{{j}^{′}}}^{⋆} , δ , α , ζ ) \leq ℒ ( {Υ}^{⋆} , {w}_{{j}^{′} , {k}_{{j}^{′}}}^{⋆} , {δ}^{*} , {α}^{*} , {ζ}^{⋆} ) \leq ℒ ( Υ , {w}_{{j}^{′} , {k}_{{j}^{′}}} , {δ}^{*} , {α}^{*} , {ζ}^{⋆} ) \qquad ( 55 )$$

Theorem 1: Let p* and d* be the optimal values of the non-convex quadratic problem and the dual problem, respectively. If

$$( {Υ}^{⋆} , {w}_{{j}^{′} , {k}_{{j}^{′}}^{*}} , {δ}^{*} , {α}^{*} , {ζ}^{⋆} ) .$$

is a saddle point of

$$ℒ ( Υ , {w}_{{j}^{′} , {k}_{{j}^{′}}^{′}} δ , α , ζ ) ,$$

then strong duality d*=p* is satisfied. Conversely, if d* is finite, and (δ*, α*, ζ*)=argmax_{δ,α,ζ≥0}g(δ, α, ζ), and the original problem has an optimal solution at

$$( {Υ}^{⋆} , {w}_{{j}^{′} , {k}_{{j}^{′}}}^{⋆} ) , then ( {Υ}^{⋆} , {w}_{{j}^{′} , {k}_{j}^{′}}^{⋆} , {δ}^{*} , {α}^{*} , {\dot{ζ}}^{⋆} )$$

is a saddle point of

$$ℒ ( Υ , {w}_{{j}^{′} , {k}_{{j}^{′}}} , δ , α , ζ ) .$$

Theorem 2: the condition for the existence of a saddle point of

$$ℒ ( Υ , {w}_{{j}^{′} , {k}_{{j}^{′}}^{′}} δ , α , ζ )$$

that there exists (δ*, α*, ζ*) such that

$$ℒ ( Υ , {w}_{{j}^{′} , {k}_{{j}^{′}}^{′}} {δ}^{*} , {α}^{*} , {ζ}^{⋆} )$$

is convex and there is a minimum

$$( {Υ}^{⋆} , {w}_{{j}^{′} , {k}_{j}^{′}}^{⋆} )$$

satisfying the following conditions:

$${δ}_{j , i}^{⋆} ( Υ - {a}_{j , i} ( {f}_{N} ( {w}_{{j}^{′} , {k}_{{j}^{′}}}^{⋆} ) - η {f}_{D} ( {w}_{{j}^{′} , {k}_{{j}^{′}}}^{⋆} ) ) = 0 \qquad ( 56 )$$

$$Υ - {a}_{j , i} ( {f}_{N} ( {w}_{{j}^{′} , {k}_{{j}^{′}}}^{⋆} ) - η {f}_{D} ( {w}_{{j}^{′} , {k}_{{j}^{′}}}^{⋆} ) \leq 0 \qquad ( 57 )$$

$${α}_{{j}^{′} , {k}_{{j}^{′}}}^{⋆} ( {γ}_{min} - {γ}_{{k}_{{j}^{′}}} ( {w}_{{j}^{′} , {k}_{{j}^{′}}}^{⋆} ) ) = 0 \qquad ( 58 )$$

$${γ}_{min} - {γ}_{{k}_{{j}^{′}}} ( {w}_{{j}^{′} , {k}_{{j}^{′}}}^{⋆} ) \leq 0 \qquad ( 59 )$$

$${ζ}_{{j}^{′}}^{⋆} ( {\sum }_{{k}_{{j}^{′}} = 1}^{{K}_{{j}^{′}}} {‖ {w}_{{j}^{′} , {k}_{{j}^{′}}}^{⋆} ‖}^{2} - {P}_{0} ) = 0 \qquad ( 60 )$$

$${‖ {w}_{{j}^{′} , {k}_{{j}^{′}}}^{⋆} ‖}^{2} - {P}_{0} \leq 0 \qquad ( 61 )$$

The proof of this theorem can be easily extended from the deduction of prior art to multiple constraints.

Therefore, to prove the strong duality of the non-convex quadratic optimization problem and obtain the optimal solution through the dual method, it is necessary to find a saddle point satisfying Theorem 2.

Due to the convexity of the dual problem P6 with respect to the Lagrange multiplier, its optimal solution (δ*, α*, ζ*) can be obtained through standard convex optimization techniques or interior point methods. Considering that Π is defined as a positive definite matrix in (50) to ensure the finiteness of the dual function formula (49), the Lagrangian function formula (49) is proven to be convex on

$${\{ {w}_{{j}^{′} , {k}_{{j}^{′}}} \}}_{{j}^{′} ∈ 𝒥 , {k}_{{j}^{′}} ∈ {𝒦}_{{j}^{′}}}$$

and γ. Therefore, it is only necessary to find:

$$Υ , {\{ {w}_{{j}^{′} , {k}_{j}^{′}} \}}_{{j}^{′} ∈ 𝒥 , {k}_{{j}^{′}} ∈ {𝒦}_{{j}^{′}}} ∈ arg {min}_{Υ , {w}_{{j}^{′} , {k}_{{j}^{′}}}} ℒ ( Υ , {w}_{{j}^{′} , {k}_{{j}^{′}}} , {δ}^{*} , {α}^{*} , {ζ}^{*} )$$

If Π>0, it means that Π is a full-rank matrix with all positive eigenvalues, so the null space of Π is the zero vector, and

$${w}_{{j}^{′} , {k}_{{j}^{′}}} = 0$$

is designed to minimize formula (49). If Π [symbol] 0, then there is an eigenvalue of 0. Therefore, Π is not a full-rank matrix and has a non-zero null space. From this derivation, the null space of Π spans the unit norm eigenvector u_{Π} with eigenvalue 0 i.e., Πu_{Π}=0. Therefore,

$${w}_{j ′ , {k}_{j ′}}^{*} = \sqrt{{P}_{0}} {u}_{Π}$$

can be chosen to minimize formula (49), which can be calculated from formula (60).

Based on this, γ* can also be obtained from condition (56), i.e.:

$${δ}_{j , i}^{*} ( Υ - {a}_{j , i} {\sum }_{j ′ = 1}^{I} {\sum }_{{k}_{j ′} = 1}^{{K}_{j ′}} {β}_{j ′ , j , i}^{2} {w}_{j ′ , {k}_{j ′}}^{* H} {c}_{j , i} {w}_{j ′ , {k}_{j ′}}^{*} + η ( {\sum }_{{j}^{′} = 1}^{J} {\sum }_{{k}_{{j}^{′}} = 1}^{{K}_{{j}^{′}}} {w}_{{j}^{′} , {k}_{{j}^{′}}}^{* H} {D}_{j , i} {w}_{{j}^{′} , {k}_{j}}^{*} + {u}_{j , i}^{H} {σ}_{n}^{2} {I}_{{M}_{r}} {u}_{j , i} ) ) = 0 , \qquad ( 62 )$$

which is equivalent to:

$${Υ}^{*} = {min}_{∀ i ∈ 𝒥} {a}_{j , i} {\sum }_{j ′ = 1}^{J} {\sum }_{{k}_{j ′} = 1}^{{K}_{j ′}} {β}_{j ′ , j , i}^{2} {w}_{j ′ , {k}_{j ′}}^{* H} {c}_{j , i} {w}_{j ′ , {k}_{j ′}}^{*} - η ( {\sum }_{{j}^{′} = 1}^{J} {\sum }_{{k}_{{j}^{′}} = 1}^{{K}_{{j}^{′}}} {w}_{{j}^{′} , {k}_{{j}^{′}}}^{* H} {D}_{j , i} {w}_{{j}^{′} , {k}_{j}}^{*} + {u}_{j , i}^{H} {σ}_{n}^{2} {I}_{{M}_{r}} {u}_{j , i} ) \qquad ( 63 )$$

Target scheduling optimization sub-problem:
observing the Lagrangian function (49), a_{j,i} is only related to the first term. Therefore, given the strong duality proven above, the Lagrangian function can be decomposed into multiple independent functions which are solved independently:

$${ℒ}_{j , i} = {δ}_{j , i} ( Υ - {a}_{j , i} {\sum }_{j ′ = 1}^{J} {\sum }_{{k}_{{j}^{′}} = 1}^{{K}_{j ′}} {β}_{j ′ , j , i}^{2} {w}_{j ′ , {k}_{j ′}}^{H} {c}_{j , i} {w}_{j ′ , {k}_{j ′}} + η {a}_{j , i} ( {\sum }_{j ′ = 1}^{J} {\sum }_{{k}_{j ′} = 1}^{{K}_{j ′}} {w}_{j ′ , {k}_{j ′}}^{* H} {D}_{j , i} {w}_{j ′ , {k}_{j}}^{} + {u}_{j , i}^{H} {σ}_{n}^{2} {I}_{{M}_{r}} {u}_{j , i} ) ) \qquad ( 64 )$$

Therefore, the independent sub-problems can be expressed as:

$${min}_{{a}_{j , i}} {ℒ}_{j , i} ( {a}_{j , i} ) \qquad ( 65 )$$

To minimize each [symbol] _{j,i}(a_{j,i}), the optimal a_{j,i} can be expressed as:

$${a}_{j , i} = \{ \begin{matrix}1 , & j = {j}^{*} = arg {min}_{j} {ℒ}_{j , i} ( {a}_{j , i} ) , \\ 0 , & otherwise .\end{matrix} \qquad ( 66 )$$

Considering that the BS scheduling decision for each target a_{j,i} ∀i∈ [symbol] is independent of each other, the target scheduling problem can be decoupled into an independent decision for each target. This significantly simplifies the problem, enabling to independently schedule each target based on the highest achievable SINR. This approach not only simplifies the computational process but also conforms to the max-min fairness criterion, ensuring that the target even in the worst sensing condition possesses sufficient resources.

By iteratively computing the above three sub-problems, the multi-base station collaborative sensing resource allocation result can be obtained.

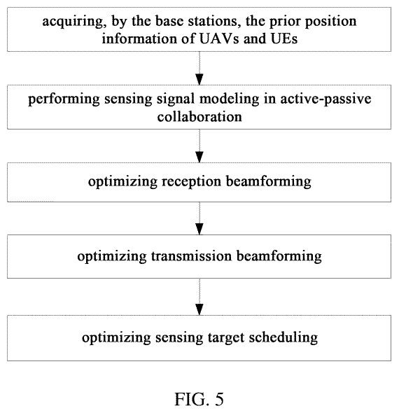

This section proposes a resource scheduling method for multi-base station collaborative ISAC based on active-passive collaboration, where multiple base stations simultaneously perform multi-target sensing and communication. By using downlink communication signals for sensing and combining with reception beamforming, the SINR model for target sensing and downlink communication is mathematically established. The optimization problem is formulated as a joint optimization of multi-target scheduling, base station transmission beamforming, and reception beamforming, with the goal of maximizing the minimum radar sensing SINR. Given the transmission beamforming and target scheduling, the optimal reception beamforming matrix is obtained by solving the problem through the generalized Rayleigh entropy; the fractional structure of the original problem is handled using the Dinkelbach method, and then the optimal transmission beamforming matrix is derived using the Lagrange dual method; based on the optimization of transmission and reception beamforming variables, the target scheduling variables are optimized according to the highest SINR, ensuring fairness in multi-target sensing. The final resource optimization result is obtained through iterative computation of the three sub-algorithms, as shown in the process in FIG. 5:
acquiring, by the base stations, the prior position information of UAVs and UEs, performing sensing signal modeling in active-passive collaboration i.e., performing signal modeling in the active-passive collaboration mode, optimizing reception beamforming, optimizing transmission beamforming, and optimizing sensing target scheduling.

Considering the inflexibility of traditional optimization algorithms in real environments, it is difficult to choose a sensing mode (active sensing mode and collaborative sensing mode) based on the actual environment, resulting in low resource allocation efficiency. Furthermore, executing the aforementioned resource allocation algorithm requires iterative computation for optimization, making it difficult to adapt to rapidly changing sensing target motion states, thereby causing time lag in resource allocation and affecting the real-time performance of sensing. Therefore, based on the idea of dual-driving with data and knowledge, this section designs a data-driven resource allocation method based on generative AI that can compute the sensing mode selection and resource allocation result according to real-time sensing requirements. Combined with the knowledge-driven method driven by traditional optimization algorithms in the previous part, constraints for the data-driven method are achieved to ensure the accuracy of the data-driven method. Specifically, the generative AI includes a feature extraction module, a feature clustering module, a cross-domain invariant feature extraction module, and a domain feature module.

In an optional embodiment, training by using the second communication and sensing related information and the second sensing mode, and/or using the second communication and sensing related information and the second resource allocation information, to obtain the AI resource optimization model, includes:
performing feature extraction on the second communication and sensing related information to obtain first extracted features;
wherein, the main purpose of the feature extraction module is to perform vector embedding on various resource constraints, communication and sensing indicator requirements, a network topology, and other time series data in the communication and sensing related information, and then concatenate and merge them to provide a high-quality input feature for the subsequent generative AI model.
   Specifically, the feature vector construction process includes:
   setting different constraints and indicators in the system, including resource constraints, network topology, and communication and sensing indicator requirements, etc. The feature vector construction process for each case sᵢ is as follows:
   Resource constraint vector (Rᵢ):
   the resource constraints can include power limitations. Assuming that there are M resource constraints, the resource constraint vector is:

$${R}_{i} = ⌊ {R}_{i 1} , {R}_{i 2} , … , {R}_{i M} ⌋$$

Communication and sensing indicator vector (Cᵢ):
the communication and sensing indicators include SINR. Assuming that there are P communication and sensing indicators, the communication and sensing indicator vector is:

$${C}_{i} = [ {C}_{í1} , {C}_{i 2} , … , {C}_{iP} ]$$

Base station vector (Bᵢ):
the base station vector describes positions of J base stations. Assuming that there are Q base stations, the base station vector is

$${B}_{i} = [ {B}_{i 1} , {B}_{i 2} , … , {B}_{i Q} ]$$

Communication user vector (Uᵢ):
the communication user vector describes positions of K communication users. Assuming that there are R users, the communication user vector is:

$${U}_{i} = [ {U}_{i 1} , {U}_{i 2} , … , {U}_{iR} ]$$

Sensing target vector (Gᵢ):
the sensing target vector describes the position of I UAV sensing target. Assuming that there are S target features, the sensing target vector is:

$${G}_{i} = [ {G}_{i 1} , {G}_{i 2} , … , {G}_{iS} ]$$

Through these steps and formulas, the feature extraction module can be constructed in detail, effectively vectorizing and embedding data of various resource constraints, network topology, and communication and sensing indicator requirements, to provide a reliable input feature for the generative AI-based resource allocation algorithm.
Vector embedding:
performing embedding process on the above vectors to obtain corresponding embedding vectors. Assuming that the embedding function is ¢, the embedding vectors are expressed as:

$$\begin{matrix}{E}_{R} = {ϕ}_{R} ( {R}_{i} ) , & {E}_{C} = {ϕ}_{C} ( {C}_{i} ) , & {E}_{B} = {ϕ}_{B} ( {B}_{i} ) , \\ {E}_{U} = {ϕ}_{U} ( {U}_{i} ) , & {E}_{G} = {ϕ}_{G} ( {G}_{i} ) & \end{matrix}$$

Concatenating and merging the embedding vectors of resource constraints, communication and sensing indicators, base stations, communication users, and a sensing target to form the final feature vector, i.e., the first extracted feature:

$${F}_{i} = [ {E}_{R} ; {E}_{C} ; {E}_{B} ; {E}_{U} ; {E}_{G} ] ,$$

wherein, [;] denotes the vector concatenation operation.

Performing feature clustering on the first extracted features to obtain multiple feature domains;
wherein, the goal of the feature clustering module is to aggregate similar cases to form one domain, so as to share feature information using the similarity of these cases in the feature space.
   Commonly used clustering algorithms include K-means, Hierarchical Clustering, Density-Based Spatial Clustering of Applications with Noise (DBSCAN), etc. In this solution, the choice of a suitable clustering algorithm depends on the nature of the feature vectors and the data scale.
   K-means is a distance-based clustering algorithm that is suitable for most datasets. The goal is to divide data into K clusters so that a distance between each data point and a center of a cluster to which the data point belongs, is minimized.
   There is no need for Hierarchical clustering to pre-specify the number of clusters. By constructing a tree-like hierarchical structure, the clustering level can be selected as needed.
   Assuming that the K-means clustering algorithm is selected, the specific process is as follows:
   Feature matrix construction: forming a feature matrix F from feature vectors Fᵢ of all cases:

$$F = [ \begin{matrix}{F}_{s 1} \\ {F}_{s 2} \\ ⋮ \\ {F}_{sn}\end{matrix} ] ,$$

wherein F∈ [symbol] ^{n×d}, n is the number of cases, d is the dimension of each feature wherein, FEW vector.
Randomly selecting K initial cluster centers μ₁, μ₂, . . . , μ_{K}. Each feature vector is assigned to a nearest cluster center based on distances between the feature vector and the cluster centers. The distance between feature vector Fᵢ and cluster center μₖ is set as d(Fᵢ, μₖ), then a cluster label to which the i-th feature vector belongs is: cᵢ=argminₖd(Fᵢ, μₖ).
Calculating a new center for each cluster, i.e., the mean of all data points assigned to the cluster:

$${μ}_{k} = \frac{1}{\vert {C}_{j} \vert} {\sum }_{{F}_{i} ∈ {C}_{k}} {F}_{i} ,$$

wherein, Cₖ is a set for the k-th cluster, |Cₖ| is the number of its data points. Iteration is performed, to repeat the clustering steps until the cluster center no longer changes or the maximum number of iterations is reached.
Through clustering, similar cases are aggregated into one feature domain, and cases within each domain share feature information. The k-th cluster domain is set to be Dₖ containing cases

$$\{ {s}_{{i}_{1}} , {s}_{{i}_{2}} , … , {s}_{{i}_{\vert {D}_{k}}} \} ,$$

then a feature vector of each domain is expressed as:

$${F}_{{D}_{k}} = \{ {F}_{{i}_{1}} , {F}_{{i}_{2}} , … , {F}_{{i}_{\vert {D}_{k} \vert}} \} .$$

Performing weighting processing on extracted features within same one of the feature domains to obtain a first domain feature representation;
Specifically, the domain feature module further processes the features within each domain to adapt to the task requirements of the specific domain. Specifically, an attention mechanism and a fully connected layer are used for feature processing, and the final feature representation is obtained in combination with cross-domain invariant features. The specific steps are as follows:
Intra-domain feature processing:
performing weighting processing using the attention mechanism for features within each domain, and then obtaining the domain feature representation i.e., the first domain feature representation, through the fully connected layer.
Attention mechanism:
applying the attention mechanism to each case in each domain to calculate attention weights. The input feature is set to be Fᵢ, then the attention weight is αᵢ:

$${α}_{i} = \frac{exp ( {W}_{a} {F}_{i} )}{{\sum }_{j} exp ( {W}_{a} {F}_{j} )} ,$$

wherein, Wₐ is a parameter matrix for the attention weight.
Weighted feature representation:
applying the attention weight to the feature to obtain the weighted feature representation:

$${F}_{i , att} = {α}_{i} {F}_{i}$$

Domain feature fusion:
Fusing all features within the domain that have been processed by the attention mechanism to obtain the domain feature representation:

$${F}_{d} = {\sum }_{i} {F}_{i , att}$$

Fully connected layer:
further processing the domain feature through a fully connected layer to obtain the final intra-domain feature representation i.e., the first domain feature representation:

$${F}_{d} = {W}_{d} {F}_{d} + {b}_{d} ,$$

wherein, W_{d} and b_{d} are the parameters of the fully connected layer.

Performing feature extraction and fusion on extracted features within different ones of the feature domains to obtain a second domain feature representation;
Domain invariant feature processing:
the goal of the cross-domain invariant feature extraction module is to extract consistent features from data of different domains, so that these features can be shared and applied across different domains. This ensures that the generative AI model has consistency and robustness when processing unseen data. The following are the specific steps and related formulas:
Feature extraction:
inputting the feature vector of each domain into the cross-domain feature extraction model to extract a cross-domain invariant feature. Assuming that the input feature vector is Fᵢ, the cross-domain invariant feature is expressed as Fᵢₙᵥ.

$${F}_{i} = [ {F}_{Ri} ; {F}_{Ti} ; {F}_{Ci} ; {F}_{Bi} ; {F}_{Ui} ; {F}_{Gi} ]$$

The cross-domain invariant feature is extracted by using a deep neural network (DNN). The cross-domain feature extraction network is set to be ψ, then:

$${F}_{inv , i} = ψ ( {F}_{i} )$$

Here, ψ can be a multilayer perceptron (MLP), consisting of multiple fully connected layers and activation functions:

$${F}_{inv , i} = ψ ( {F}_{i} ) = {f}_{L} ( {W}_{L} ( {f}_{L - 1} ( ⋯ {f}_{1} ( {W}_{1} {F}_{i} + {b}_{1} ) ⋯ ) + {b}_{L - 1} ) + {b}_{L} )$$

wherein, L represents the number of layers of the network, Wₗ and bₗ are the weight matrix and bias vector of the l-th layer, respectively, wherein l=1, 2, . . . , L, and fₗ is the activation function of the l-th layer, such as ReLU, Sigmoid, etc.,
Fusion of features of all cases:
to obtain cross-domain invariant feature representation, fusing the features of all cases. Assuming that there are n cases, the fused cross-domain invariant feature representation, i.e., the second domain feature representation, is:

$${F}_{inv} = \frac{1}{n} {\sum }_{i = 1}^{n} {F}_{inv , i}$$

This step ensures consistency among different domains and fuses the features of all cases.

Obtaining a target feature representation according to the first domain feature representation and the second domain feature representation;
Specifically, cross-domain feature combination:
concatenating or adding the intra-domain feature representation with the cross-domain invariant feature to form the final feature representation i.e., the target feature representation.

$${F}_{final} = [ {F}_{d} ; {F}_{inv} ]$$

$${F}_{final} = {F}_{d} + {F}_{inv}$$

training by using the target feature representation and the second sensing mode, and/or using the target feature representation and the second resource allocation information, to obtain the AI resource optimization model.

In an optional embodiment, training by using the target feature representation and the second resource allocation information, to obtain the AI resource optimization model, includes:
obtaining first training resource allocation information according to the target feature representation by using a preset optimization method;
wherein, the preset optimization method is an existing traditional optimization algorithm, such as convex optimization, sequential approximation, and other mathematical methods;
obtaining second training resource allocation information according to the target feature representation by using a preset initial AI model;
obtaining a loss function according to the first training resource allocation information and the second training resource allocation information;
adjusting model parameters in the initial AI model to reduce the loss function, to obtain the AI resource optimization model.

Specifically, the solution obtained by the traditional optimization algorithm is used as the label, and the mean squared error (MSE) loss is used for optimization to solve the loss function.

The solution obtained by the traditional optimization algorithm, i.e., the first training resource allocation information, is set to be Rₒₚₜ, and the output of the generative AI model is set to be R_{gen}, i.e., the second training resource allocation information, then the loss function is:

$${ℒ}_{MSE} = \frac{i}{n} {\sum }_{i = 1}^{n} {( {R}_{gen , i} - {R}_{opt , i} )}^{2}$$

the model parameters is updated by using gradient descent or other optimization algorithms, to minimize the loss function, and the parameters of the generative AI model are trained so that the resource allocation result output by the generative AI model is as close as possible to the solution by the traditional optimization algorithm.

Through the above steps and formulas, the cross-domain invariant feature extraction module can effectively process and combine feature information from different domains. The model can automatically select the sensing mode based on data features, improving the accuracy and efficiency of the generative AI model in resource allocation. The generated model only needs to input data into the domain invariant feature module, then the model can decide the sensing method and resource allocation.

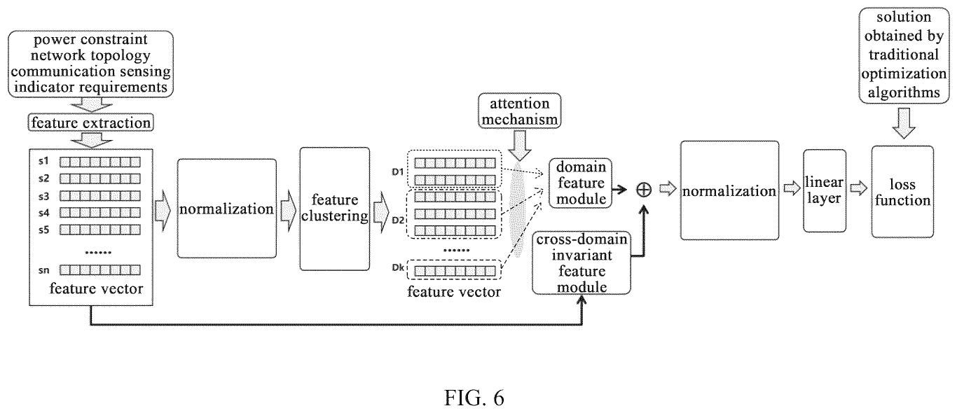

Below, with reference to FIG. 6, the training process of the AI resource optimization model provided by the embodiment of the present invention is specifically described:
performing feature extraction on various resource constraints, communication and sensing indicator requirements, network topology, etc., in the communication and sensing related information to obtain the feature vector i.e., the first extracted feature; performing normalization and feature clustering on the feature vector; and introducing an attention mechanism to obtain the first domain feature representation in the domain feature module, and obtaining the second domain feature representation in the cross-domain invariant feature module; obtaining the target feature representation according to the first domain feature representation and the second domain feature representation; performing normalization on the target feature representation, and obtaining the second training resource allocation information through a linear layer; obtaining the first training resource allocation information by using the traditional optimization algorithm; obtaining the loss function according to the second training resource allocation information and the first training resource allocation information; adjusting the model parameters in the initial AI model to reduce the loss function, thereby obtaining the direct correspondence between training resource allocation information and communication resource related information in the AI resource optimization model.

It should be noted that the training process for the correspondence between the sensing mode and communication resource related information in the AI resource optimization model is basically consistent with that for the direct correspondence between training resource allocation information and communication resource related information in the AI resource optimization model.

By introducing generative AI, the embodiment of the present invention achieves intelligent management of the two sensing modes and adaptive resource allocation. The generative AI can dynamically adjust the beam and power allocation strategy of the system according to environmental changes, characteristics of sensing targets, and communication and sensing QoS requirements. The generative AI first trains on historical data to extract intra-domain and extra-domain features, enabling real-time learning and prediction of sensing and communication requirements in different scenarios. The AI model selects the A-transmitting and A-receiving mode or A-transmitting and B-receiving mode based on the scenario and automatically allocates beam direction and power resources. In different scenarios, the AI autonomously decides which sensing mode is to be adopted. When there are many communication tasks around the base station, the AI prioritizes the A-transmitting and B-receiving mode to reduce the burden on a single base station; when high precision is required, it selects the A-transmitting and A-receiving mode. The AI ensures the best balance between communication and sensing tasks under resource competition through optimization algorithms. Multi-objective optimization is that, when dealing with multiple sensing targets, the AI combines the QoS requirements of different targets and optimizes through an exponential utility function, ensuring that a target with high-threat or high-priority possesses more resources, while a target with low-priority maintains the basic sensing capability.

The present invention proposes a multi-base station beam and power allocation technology that adapts to different communication and sensing QoS requirements. This solution is based on the current base station deployment in a current cellular network. By introducing the A-transmitting and A-receiving mode and A-transmitting and B-receiving sensing mode, the generative AI is used for adaptive learning and optimization of the environment, dynamically switching the sensing mode according to the scenario, and autonomously allocating beam and power resources based on different communication and sensing requirements, achieving efficient ISAC resource management. Specifically, first, multi-base station resource optimization schemes are designed for the A-transmitting and A-receiving active sensing mode and the A-transmitting and B-receiving active-passive collaborative sensing method, respectively, and the condition information and resource allocation results of the two optimization schemes are used as training data for the generative AI model. Secondly, a generative AI model based on the transformer architecture is constructed. This model includes a domain invariant feature extraction module and a cross-domain feature extraction module, which can effectively extract common feature information in the two sensing modes and feature information under specific conditions, achieving reliable resource allocation under unknown environmental conditions and precise resource allocation under known environmental conditions.

Wherein, the feature extraction module can effectively embed various resource constraints, network topology, communication and sensing indicators such as SINR, base station locations, user locations, sensing target locations, and other information into a unified feature vector, ensuring standardized and quantized data processing in multi-base station collaborative communication and sensing task. This module provides the normalized input feature for the generative AI model, ensuring the accuracy and consistency of resource allocation. The cross-domain invariant feature extraction module can identify and extract invariant features in different scenarios or domains and embed these features into the feature representation for a specific resource optimization scenario, enhancing the generalization ability and robustness of the model. This module ensures that the generative AI can maintain the stability and consistency of resource allocation decision when the environment changes dynamically, achieving efficient communication and sensing resource allocation in cross-domain scenario; the feature fusion and connection module combines cross-domain invariant features with resource constraint features of specific scenarios through DNN to form a unified feature vector. Through the multi-layer fully connected structure and activation function processing, it ensures the effective combination of multi-domain features, improves the accuracy of resource allocation by the system in complex and dynamic scenarios, and ensures real-time resource scheduling optimization for communication and sensing tasks. For the multi-base station A-transmitting and A-receiving active sensing system, an optimization problem modeling for differentiated QoS requirements is proposed. Resource allocation modeling is achieved through an exponential utility function, ensuring equal emphasis on both the sensing accuracy and communication quality of different targets. This method can adapt to changing requirements in different scenarios and has high efficiency and flexibility.

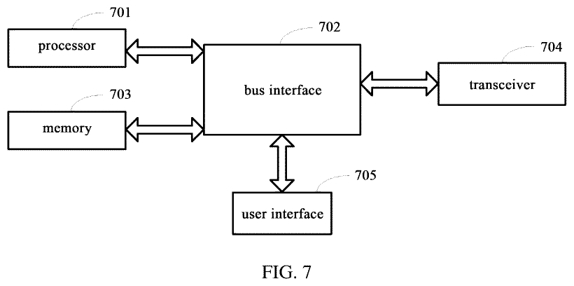

As shown in FIG. 7, an embodiment of the present invention further provides a generative AI-based multi-base station collaborative sensing resource optimization apparatus, including: a processor 701; and a memory 703 connected to the processor 701 via a bus interface 702. The memory 703 is configured for storing programs and data used by the processor 701 when performing operations. The processor 701 calls and executes the programs and data stored in the memory 703.

Wherein, the transceiver 704 is connected to the bus interface 702 and is configured for receiving and transmitting data under the control of the processor 701. Specifically, the processor 701 is configured for reading the program in the memory 703, and when the processor 701 carries out the generative AI-based multi-base station collaborative sensing resource optimization method in above embodiments when executing the program.

In FIG. 7, the bus architecture may include any number of interconnected buses and bridges, specifically linking various circuits represented by one or more processors represented by the processor 701 and a memory represented by the memory 703. The bus architecture may also link various other circuits such as peripheral devices, voltage regulators, and power management circuits, which are well known in the art, and therefore, will not be further described herein. The bus interface provides a user interface 705. The transceiver 704 may be multiple elements, i.e., including a transmitter and a receiver, for providing units for communicating with various other devices on a transmission medium. The processor 701 is responsible for managing the bus architecture and general processing, and the memory 703 may store data used by the processor 701 when performing operations.

In addition, a specific embodiment of the present invention further provides a readable storage medium having stored thereon a computer program which, when executed by a processor, carries out the generative AI-based multi-base station collaborative sensing resource optimization method according to any one of the above embodiments.

In the several embodiments provided in the present application, it should be understood that the displayed or discussed mutual coupling or direct coupling or communication connection may be achieved through some interfaces, indirect coupling or communication connection between devices or units, and may be electrical, mechanical, or other forms.

The aforementioned storage medium includes U disk, mobile hard disk, Read-Only Memory (abbreviated as ROM), Random Access Memory (abbreviated as RAM), magnetic disk, or optical disk, and other various media that can store program code.

The above are the preferred embodiments of the present invention. It should be pointed out that for those of ordinary skill in the art, several improvements and modifications can be made without departing from the principles of the present invention, and these improvements and modifications are also fall within the protection scope of the present invention.

1. A generative AI-based multi-base station collaborative sensing resource optimization method, comprising:
acquiring first communication and sensing related information of a first multi-base station collaborative Integrated Sensing and Communication, ISAC, system; and
inputting the first communication and sensing related information into a trained Artificial Intelligence, AI, resource optimization model to obtain first resource allocation information of the first multi-base station collaborative ISAC system and/or a first sensing mode of the first multi-base station collaborative ISAC system output by the AI resource optimization model;
wherein the AI resource optimization model is configured to indicate at least one of:
a correspondence between communication and sensing related information and resource allocation information;
a correspondence between communication and sensing related information and a sensing mode.

2. The method according to claim 1, wherein, the method further comprises:
acquiring second communication and sensing related information, a second sensing mode, and second resource allocation information of a second multi-base station collaborative ISAC system; and
training by using the second communication and sensing related information and the second sensing mode, and/or using the second communication and sensing related information and the second resource allocation information, to obtain the AI resource optimization model.

3. The method according to claim 1, wherein, the communication and sensing related information comprises at least one of:
base stations;
a communication user;
sensing targets;
resource constraint information;
communication and sensing indicator information.

4. The method according to claim 1, wherein, the sensing mode comprises at least one of:
an active sensing mode;
a collaborative sensing mode.

5. The method according to claim 2, wherein, acquiring the second resource allocation information of the second multi-base station collaborative ISAC system comprises:
acquiring downlink communication signals received by a communication user from base stations, an echo signal reflected by sensing targets and received by each of the base stations, and beam power allocation information of the base stations, in the second multi-base station collaborative ISAC system in an active sensing mode;
generating a first optimization objective for resource allocation optimization in the active sensing mode according to the echo signal reflected by the sensing targets and received by each of the base stations;
generating a first optimization constraint condition for resource allocation optimization in the active sensing mode according to the downlink communication signals received by the communication user from the base stations and the beam power allocation information of the base stations;
performing resource allocation optimization on the second multi-base station collaborative ISAC system in the active sensing mode according to the first optimization objective and the first optimization constraint condition, to obtain the second resource allocation information in the active sensing mode.

6. The method according to claim 5, wherein, generating the first optimization objective for resource allocation optimization in the active sensing mode according to the echo signal reflected by the sensing targets and received by each of the base stations comprises:
performing separation and filtering processing on the echo signal reflected by the sensing targets and received by each of the base station to obtain first filtered echo signals;
generating a Cramer-Rao Lower Bound, CRLB, for sensing performance of each of the sensing targets according to the first filtered echo signals;
obtaining a first global positioning performance of the sensing targets according to the CRLB of each of the sensing targets, an echo azimuth angle of arrival, AoA, for each of the sensing targets relative to each of the base stations, and an echo zenith angle of arrival, ZoA, for each of the sensing targets relative to each of the base stations;
generating the first optimization objective according to the first global positioning performance.

7. The method according to claim 5, wherein, generating the first optimization constraint condition for resource allocation optimization in the active sensing mode according to the downlink communication signals received by the communication user from the base stations and the beam power allocation information of the base stations comprises:
obtaining a first Signal-to-Interference-plus-Noise Ratio (SINR) for reception of the communication user according to the downlink communication signals received by the communication user from the base stations;
taking the first SINR being greater than or equal to a first preset SINR threshold as a first condition;
obtaining a transmission power of each of the base station and the number of beams supported by each of the base stations according to power allocation information of the base stations and the beam power allocation information of the base stations;
taking the transmission power of each of the base station being less than or equal to a first preset power threshold as a second condition;
taking the number of beams supported by each of the base stations being less than or equal to a first preset number as a third condition;
generating a fourth condition according to a preset beam selection matrix;
obtaining the first optimization constraint condition according to the first condition, the second condition, the third condition, and the fourth condition.

8. The method according to claim 7, wherein, performing resource allocation optimization on the second multi-base station collaborative ISAC system in the active sensing mode according to the first optimization objective and the first optimization constraint condition to obtain the second resource allocation information in the active sensing mode comprises:
performing approximate convex relaxation processing on the fourth condition in the first optimization constraint condition to obtain a fifth condition;
decomposing the first optimization objective into a first sub-objective and a second sub-objective using an initial beam selection matrix;
obtaining numerator information and denominator information in the first SINR for reception of the communication user according to the initial beam selection matrix;
converting the first condition in the first optimization constraint condition into a sixth condition according to the numerator information and the denominator information;
generating a first optimization problem according to the first sub-objective, the sixth condition, and the second condition in the first optimization constraint condition;
generating a second optimization problem according to the second sub-objective, the sixth condition, the third condition in the first optimization constraint condition, and the fifth condition;
obtaining the second resource allocation information in the active sensing mode by alternately solving the first optimization problem and the second optimization problem.

9. The method according to claim 2, wherein, acquiring the second resource allocation information of the second multi-base station collaborative ISAC system comprises:
acquiring a transmission signal of a first base station in the second multi-base station collaborative ISAC system, a reception signal of a first communication user communicating with the first base station, and a reflection signal received by the first base station in a collaborative sensing mode;
obtaining a second SINR for the first communication user according to the transmission signal of the first base station and the reception signal of the first communication user;
obtaining a third SINR of a radar output signal for a sensing target at the first base station according to the reflection signal received by the first base station;
generating a second optimization objective according to the second SINR;
generating a second optimization constraint condition for resource allocation optimization in the collaborative sensing mode according to the third SINR and power budget information of the first base station;
performing resource allocation optimization on the second multi-base station collaborative ISAC system in the collaborative sensing mode according to the second optimization objective and the second optimization constraint condition to obtain the second resource allocation information in the collaborative sensing mode.

10. The method according to claim 9, wherein, generating the second optimization constraint condition for resource allocation optimization in the collaborative sensing mode according to the third SINR and the power budget information of the first base station comprises:
taking the third SINR being greater than or equal to a second preset SINR threshold as a seventh condition;
taking a transmission power of the first base station is less than or equal to a second preset power threshold indicated by the power budget information of the first base station as an eighth condition;
generating a ninth condition according to a preset target scheduling matrix;
obtaining the second optimization constraint condition according to the seventh condition, the eighth condition, and the ninth condition.

11. The method according to claim 10, wherein, performing resource allocation optimization on the second multi-base station collaborative ISAC system in the collaborative sensing mode according to the second optimization objective and the second optimization constraint condition to obtain the second resource allocation information in the collaborative sensing mode comprises:
converting the second optimization objective into a third optimization problem according to a transmission beamforming matrix and the target scheduling matrix;
solving the third optimization problem by using generalized Rayleigh entropy to obtain an optimized reception beamforming matrix;
converting the second optimization objective into a third sub-objective by using a Dinkelbach method;
obtaining a fourth optimization problem according to the third sub-objective, the sixth condition and the seventh condition in the second optimization constraint condition;
solving the fourth optimization problem by using a Lagrangian dual method to obtain an optimized transmission beamforming matrix;
optimizing the target scheduling matrix according to the optimized reception beamforming matrix, the optimized transmission beamforming matrix, and the second optimization objective to obtain the second resource allocation information in the collaborative sensing mode.

12. The method according to claim 2, wherein, training by using the second communication and sensing related information and the second sensing mode, and/or using the second communication and sensing related information and the second resource allocation information, to obtain the AI resource optimization model, comprises:
performing feature extraction on the second communication and sensing related information to obtain first extracted features;
performing feature clustering on the first extracted features to obtain a plurality of feature domains;
performing weighting processing on extracted features within same one of the feature domains to obtain a first domain feature representation;
performing feature extraction and fusion on extracted features within different ones of the feature domains to obtain a second domain feature representation;
obtaining a target feature representation according to the first domain feature representation and the second domain feature representation;
training by using the target feature representation and the second sensing mode, and/or using the target feature representation and the second resource allocation information, to obtain the AI resource optimization model.

13. The method according to claim 12, wherein, training by using the target feature representation and the second resource allocation information to obtain the AI resource optimization model comprises:
obtaining first training resource allocation information according to the target feature representation by using a preset optimization method;
obtaining second training resource allocation information according to the target feature representation by using a preset initial AI model;
obtaining a loss function according to the first training resource allocation information and the second training resource allocation information;
adjusting model parameters in the initial AI model to reduce the loss function, to obtain the AI resource optimization model.

14. A generative AI-based multi-base station collaborative sensing resource optimization apparatus, comprising: a processor, a memory, and a program stored on the memory and executable on the processor, wherein the program, when executed by the processor, carries out the generative AI-based multi-base station collaborative sensing resource optimization method according to claim 1.

15. The apparatus according to claim 14, wherein the program, when executed by the processor, further carries out operations of:
acquiring second communication and sensing related information, a second sensing mode, and second resource allocation information of a second multi-base station collaborative ISAC system; and
training by using the second communication and sensing related information and the second sensing mode, and/or using the second communication and sensing related information and the second resource allocation information, to obtain the AI resource optimization model.

16. The apparatus according to claim 14, wherein the communication and sensing related information comprises at least one of:
base stations;
a communication user;
sensing targets;
resource constraint information;
communication and sensing indicator information.

17. The apparatus according to claim 15, wherein acquiring the second resource allocation information of the second multi-base station collaborative ISAC system comprises:
acquiring downlink communication signals received by a communication user from base stations, an echo signal reflected by sensing targets and received by each of the base stations, and beam power allocation information of the base stations, in the second multi-base station collaborative ISAC system in an active sensing mode;
generating a first optimization objective for resource allocation optimization in the active sensing mode according to the echo signal reflected by the sensing targets and received by each of the base stations;
generating a first optimization constraint condition for resource allocation optimization in the active sensing mode according to the downlink communication signals received by the communication user from the base stations and the beam power allocation information of the base stations;
performing resource allocation optimization on the second multi-base station collaborative ISAC system in the active sensing mode according to the first optimization objective and the first optimization constraint condition, to obtain the second resource allocation information in the active sensing mode.

18. The apparatus according to claim 15, wherein, acquiring the second resource allocation information of the second multi-base station collaborative ISAC system comprises:
acquiring a transmission signal of a first base station in the second multi-base station collaborative ISAC system, a reception signal of a first communication user communicating with the first base station, and a reflection signal received by the first base station in a collaborative sensing mode;
obtaining a second SINR for the first communication user according to the transmission signal of the first base station and the reception signal of the first communication user;
obtaining a third SINR of a radar output signal for a sensing target at the first base station according to the reflection signal received by the first base station;
generating a second optimization objective according to the second SINR;
generating a second optimization constraint condition for resource allocation optimization in the collaborative sensing mode according to the third SINR and power budget information of the first base station;
performing resource allocation optimization on the second multi-base station collaborative ISAC system in the collaborative sensing mode according to the second optimization objective and the second optimization constraint condition to obtain the second resource allocation information in the collaborative sensing mode.

19. The apparatus according to claim 15, wherein, training by using the second communication and sensing related information and the second sensing mode, and/or using the second communication and sensing related information and the second resource allocation information, to obtain the AI resource optimization model, comprises:
performing feature extraction on the second communication and sensing related information to obtain first extracted features;
performing feature clustering on the first extracted features to obtain a plurality of feature domains;
performing weighting processing on extracted features within same one of the feature domains to obtain a first domain feature representation;
performing feature extraction and fusion on extracted features within different ones of the feature domains to obtain a second domain feature representation;
obtaining a target feature representation according to the first domain feature representation and the second domain feature representation;
training by using the target feature representation and the second sensing mode, and/or using the target feature representation and the second resource allocation information, to obtain the AI resource optimization model.

20. A non-transitory readable storage medium having stored thereon a program, wherein the program, when executed by a processor, carries out the generative AI-based multi-base station collaborative sensing resource optimization method according to claim 1.
